(19) United States
(12) Patent Application Publication
(10) Pub. No.: US 2026/0303626 A1
(43) Pub. Date: Oct. 1, 2026

(54) SECURITY FOR WIRELESS COMMUNICATIONS

(71) Applicant: QUALCOMM Incorporated, San Diego, CA (US)

(72) Inventors: Jian SHEN, San Diego, CA (US); Michel Adib SARKIS, San Diego, CA (US); Joseph Patrick BURKE, Carlsbad, CA (US)

(21) Appl. No.: 19/090,302

(22) Filed: Mar. 25, 2025

(51) Int. Cl. H04L 9/40; G06F 21/16

(52) U.S. Cl. CPC H04L 63/1425; G06F 21/16; H04L 63/1441

(57) ABSTRACT

Systems and techniques are described herein for wireless networking. For instance, a method for wireless networking is provided. The method may include obtaining a plurality of network identifiers of a corresponding plurality of wireless networks; generating a list of the plurality of network identifiers; determining related network identifiers from among the plurality of network identifiers; associating the related network identifiers in an enriched list of the plurality of network identifiers; determining a suspicious network from among the plurality of wireless networks; indicating a suspicious network identifier of the suspicious network in the enriched list; and displaying the enriched list.

### TECHNICAL FIELD

The present disclosure generally relates to wireless communications. For example, aspects of the present disclosure include systems and techniques for security for wireless communications.

### BACKGROUND

Wireless electronic devices (e.g., smartphones and extended reality (XR) devices) can include hardware and software components that are configured to transmit and receive radio frequency (RF) signals. For example, an XR device can be configured to communicate via Institute of Electrical and Electronics Engineers (IEEE) 802.11 (WiFi) protocols, 5^{th} generation cellular (5G) protocols, New Radio (NR) protocols, Bluetooth™ protocols, millimeter wave (mmWave) protocols, and/or ultra-wideband (UWB) protocols, among others.

Some wireless electronic devices (e.g., augmented reality (AR) glasses) may have limited connectivity and on-device compute capability due to power, thermal, and form factor restrictions. One approach to implementing processing operations for a wireless electronic device includes using a WiFi connection between the wireless electronic device and a companion device and/or a cloud to offload many compute tasks. However, WiFi hotspots and remote clouds present security risks.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for wireless networking. According to at least one example, a method is provided for wireless networking. The method includes: obtaining a plurality of network identifiers of a corresponding plurality of wireless networks; generating a list of the plurality of network identifiers; determining related network identifiers from among the plurality of network identifiers; associating the related network identifiers in an enriched list of the plurality of network identifiers; determining a suspicious network from among the plurality of wireless networks; indicating a suspicious network identifier of the suspicious network in the enriched list; and displaying the enriched list.

In another example, an apparatus for wireless networking is provided that includes at least one memory and at least one processor (e.g., configured in circuitry) coupled to the at least one memory. The at least one processor configured to: obtain a plurality of network identifiers of a corresponding plurality of wireless networks; generate a list of the plurality of network identifiers; determine related network identifiers from among the plurality of network identifiers; associate the related network identifiers in an enriched list of the plurality of network identifiers; determine a suspicious network from among the plurality of wireless networks; indicate a suspicious network identifier of the suspicious network in the enriched list; and display the enriched list.

In another example, a non-transitory computer-readable medium is provided that has stored thereon instructions that, when executed by one or more processors, cause the one or more processors to: obtain a plurality of network identifiers of a corresponding plurality of wireless networks; generate a list of the plurality of network identifiers; determine related network identifiers from among the plurality of network identifiers; associate the related network identifiers in an enriched list of the plurality of network identifiers; determine a suspicious network from among the plurality of wireless networks; indicate a suspicious network identifier of the suspicious network in the enriched list; and display the enriched list.

In another example, an apparatus for wireless networking is provided. The apparatus includes: means for obtaining a plurality of network identifiers of a corresponding plurality of wireless networks; means for generating a list of the plurality of network identifiers; means for determining related network identifiers from among the plurality of network identifiers; means for associating the related network identifiers in an enriched list of the plurality of network identifiers; means for determining a suspicious network from among the plurality of wireless networks; means for indicating a suspicious network identifier of the suspicious network in the enriched list; and means for displaying the enriched list.

Systems and techniques are described for processing data. According to at least one example, a method is provided for processing data. The method includes: obtaining data at an extended reality (XR) device, wherein the data is based on at least one of image data captured by the XR device or audio data recorded by the XR device; capturing an image of an environment associated with the data;

classifying the environment based on the image; determining a confidentiality level associated with the data based on the environment; determining a security protocol based on the confidentiality level; and causing at least one transmitter to transmit, based on the security protocol, the data to a remote computing device for processing.

In another example, an apparatus for processing data is provided that includes at least one memory and at least one processor (e.g., configured in circuitry) coupled to the at least one memory. The at least one processor configured to: obtain data at an extended reality (XR) device, wherein the data is based on at least one of image data captured by the XR device or audio data recorded by the XR device; capture an image of an environment associated with the data; classify the environment based on the image; determine a confidentiality level associated with the data based on the environment; determine a security protocol based on the confidentiality level; and cause at least one transmitter to transmit, based on the security protocol, the data to a remote computing device for processing.

In another example, a non-transitory computer-readable medium is provided that has stored thereon instructions that, when executed by one or more processors, cause the one or more processors to: obtain data at an extended reality (XR) device, wherein the data is based on at least one of image data captured by the XR device or audio data recorded by the XR device; capture an image of an environment associated with the data; classify the environment based on the image; determine a confidentiality level associated with the data based on the environment; determine a security protocol based on the confidentiality level; and cause at least one transmitter to transmit, based on the security protocol, the data to a remote computing device for processing.

In another example, an apparatus for processing data is provided. The apparatus includes: means for obtaining data at an extended reality (XR) device, wherein the data is based on at least one of image data captured by the XR device or audio data recorded by the XR device; means for capturing an image of an environment associated with the data; means for classifying the environment based on the image; means for determining a confidentiality level associated with the data based on the environment; means for determining a security protocol based on the confidentiality level; and means for causing at least one transmitter to transmit, based on the security protocol, the data to a remote computing device for processing.

In some aspects, one or more of the apparatuses described herein is, can be part of, or can include an extended reality (XR) device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating an example extended-reality (XR) system, according to aspects of the disclosure;

FIG. 2 is a diagram illustrating another example extended reality (XR) system, according to aspects of the disclosure;

FIG. 3 is a block diagram illustrating an architecture of an example extended reality (XR) system, in accordance with some aspects of the disclosure;

FIG. 4 is a diagram representing an example environment in which a device may select a network with which to connect, according to various aspects of the present disclosure;

FIG. 5 includes an example image captured in an environment by a device;

FIG. 6 includes an example enriched list, generated according to various aspects of the present disclosure;

FIG. 7 is a diagram representing an example environment in which a device may select a cloud to process data, according to various aspects of the present disclosure;

FIG. 8 is a flow diagram illustrating an example process for wireless communications, in accordance with aspects of the present disclosure;

FIG. 9 is a flow diagram illustrating an example process for wireless communications, in accordance with aspects of the present disclosure;

FIG. 10 is a flow diagram illustrating an example process for wireless communications, in accordance with aspects of the present disclosure;

FIG. 11 is a block diagram illustrating an example of a deep learning neural network that can be used to perform various tasks, according to some aspects of the disclosed technology;

FIG. 12 is a block diagram illustrating a multimodal generative ML system for generating natural language responses based on natural language input from a prompt and any additional information;

FIG. 13 includes an example machine-learning model that may be used in various aspects of the present disclosure;

FIG. 14 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As noted previously, an extended reality (XR) system or device can provide a user with an XR experience by presenting virtual content to the user (e.g., for a completely immersive experience) and/or can combine a view of a real-world or physical environment with a display of a virtual environment (made up of virtual content). The real-world environment can include real-world objects (also referred to as physical objects), such as people, vehicles, buildings, tables, chairs, and/or other real-world or physical objects. As used herein, the terms XR system and XR device are used interchangeably. Examples of XR systems or devices include head-mounted displays (HMDs) (which may also be referred to as a head-mounted devices), XR glasses (e.g., AR glasses, MR glasses, etc.) (also referred to as smart or network-connected glasses), among others. In some cases, XR glasses are an example of an HMD. In some cases, an XR system can track parts of the user (e.g., a hand and/or fingertips of a user) to allow the user to interact with items of virtual content.

XR systems can include virtual reality (VR) systems facilitating interactions with VR environments, augmented reality (AR) systems facilitating interactions with AR environments, mixed reality (MR) systems facilitating interactions with MR environments, and/or other XR systems.

For instance, VR provides a complete immersive experience in a three-dimensional (3D) computer-generated VR environment or video depicting a virtual version of a real-world environment. VR content can include VR video in some cases, which can be captured and rendered at very high quality, potentially providing a truly immersive virtual reality experience. Virtual reality applications can include gaming, training, education, sports video, online shopping, among others. VR content can be rendered and displayed using a VR system or device, such as a VR HMD or other VR headset, which fully covers a user's eyes during a VR experience.

AR is a technology that provides virtual or computer-generated content (referred to as AR content) over the user's view of a physical, real-world scene or environment. AR content can include virtual content, such as video, images, graphic content, location data (e.g., global positioning system (GPS) data or other location data), sounds, any combination thereof, and/or other augmented content. An AR system or device is designed to enhance (or augment), rather than to replace, a person's current perception of reality. For example, a user can see a real stationary or moving physical object through an AR device display, but the user's visual perception of the physical object may be augmented or enhanced by a virtual image of that object (e.g., a real-world car replaced by a virtual image of a DeLorean), by AR content added to the physical object (e.g., virtual wings added to a live animal), by AR content displayed relative to the physical object (e.g., informational virtual content displayed near a sign on a building, a virtual coffee cup virtually anchored to (e.g., placed on top of) a real-world table in one or more images, etc.), and/or by displaying other types of AR content. Various types of AR systems can be used for gaming, entertainment, and/or other applications.

MR technologies can combine aspects of VR and AR to provide an immersive experience for a user. For example, in an MR environment, real-world and computer-generated objects can interact (e.g., a real person can interact with a virtual person as if the virtual person were a real person).

An XR environment can be interacted with in a seemingly real or physical way. As a user experiencing an XR environment (e.g., an immersive VR environment) moves in the real world, rendered virtual content (e.g., images rendered in a virtual environment in a VR experience) also changes, giving the user the perception that the user is moving within the XR environment. For example, a user can turn left or right, look up or down, and/or move forwards or backwards, thus changing the user's point of view of the XR environment. The XR content presented to the user can change accordingly, so that the user's experience in the XR environment is as seamless as it would be in the real world.

In some cases, an XR system can match the relative pose and movement of objects and devices in the physical world. For example, an XR system can use tracking information to calculate the relative pose of devices, objects, and/or features of the real-world environment in order to match the relative position and movement of the devices, objects, and/or the real-world environment. In some examples, the XR system can use the pose and movement of one or more devices, objects, and/or the real-world environment to render content relative to the real-world environment in a convincing manner. The relative pose information can be used to match virtual content with the user's perceived motion and the spatio-temporal state of the devices, objects, and real-world environment. In some cases, an XR system can track parts of the user (e.g., a hand and/or fingertips of a user) to allow the user to interact with items of virtual content.

XR systems or devices can facilitate interaction with different types of XR environments (e.g., a user can use an XR system or device to interact with an XR environment). One example of an XR environment is a metaverse virtual environment. A user may virtually interact with other users (e.g., in a social setting, in a virtual meeting, etc.), virtually shop for items (e.g., goods, services, property, etc.), to play computer games, and/or to experience other services in a metaverse virtual environment. In one illustrative example, an XR system may provide a 3D collaborative virtual environment for a group of users. The users may interact with one another via virtual representations of the users in the virtual environment. The users may visually, audibly, haptically, or otherwise experience the virtual environment while interacting with virtual representations of the other users.

A virtual representation of a user may be used to represent the user in a virtual environment. A virtual representation of a user is also referred to herein as an avatar. An avatar representing a user may mimic an appearance, movement, mannerisms, and/or other features of the user. In some examples, the user may desire that the avatar representing the person in the virtual environment appear as a digital twin of the user. In any virtual environment, it is important for an XR system to efficiently generate high-quality avatars (e.g., realistically representing the appearance, movement, etc. of the person) in a low-latency manner. It can also be important for the XR system to render audio in an effective manner to enhance the XR experience.

In some cases, an XR system can include an optical “see-through” or “pass-through” display (e.g., see-through or pass-through AR HMD or AR glasses), allowing the XR system to display XR content (e.g., AR content) directly onto a real-world view without displaying video content. For example, a user may view physical objects through a display (e.g., glasses or lenses), and the AR system can display AR content onto the display to provide the user with an enhanced visual perception of one or more real-world objects. In one example, a display of an optical see-through AR system can include a lens or glass in front of each eye (or a single lens or glass over both eyes). The see-through display can allow the user to see a real-world or physical object directly, and can display (e.g., projected or otherwise displayed) an enhanced image of that object or additional AR content to augment the user's visual perception of the real world.

As mentioned above, wireless electronic devices (e.g., smartphones and XR devices) can include hardware and software components that are configured to transmit and receive radio frequency (RF) signals. For example, an XR device can be configured to communicate via Institute of Electrical and Electronics Engineers (IEEE) 802.11 (WiFi) protocols, 5^{th} generation cellular (5G) protocols, New Radio (NR) protocols, Bluetooth™ protocols, millimeter wave (mmWave) protocols, and/or ultra-wideband (UWB) protocols, among others.

Some wireless electronic devices (e.g., AR glasses) may have limited connectivity and on-device compute capability due to power, thermal, and form factor restrictions. One approach to implementing processing operations for a wireless electronic device includes using a WiFi connection between the wireless electronic device and a companion device and/or a cloud network (also referred to as a cloud or a remote cloud) to offload computationally intensive tasks. As used herein, a cloud network refers to one or more computing devices (e.g., a network of server computing devices) that can connect to one or more other devices (e.g., the wireless electronic device) over a network, such as the Internet. In some aspects, the computing devices of the cloud network can be referred to as remote computing devices. For example, as used herein, the term “cloud” may refer to one or more computing devices with which a device may communicate. Additionally or alternatively, the term “cloud” may refer to services and/or processes that may be performed by the one or more computing devices based on data from the device. Additionally or alternatively, the term “cloud” may refer to machine-learning models that may be implemented by such computing device(s) to perform various tasks.

WiFi hotspots and remote clouds present security risks. For example, WiFi hotspots and remote clouds cannot always be trusted. For instance, when an XR device tries to connect to a free or public WiFi network in a public space, the XR device may be susceptible to a variety of threats, such as data eavesdropping and malware injection.

Additionally or alternatively, some remote clouds may present security or confidentiality concerns always. For example, some data to be processed may be confidential and a user may not want the data processed by a public cloud. For instance, when a user of XR device sends a query to summarize a page marked as company confidential information (CCI) to a public LLM on the cloud, the CCI information could be exposed publicly.

Systems, apparatuses, methods (also referred to as processes), and computer-readable media (collectively referred to herein as “systems and techniques”) are described herein for secure wireless communications. For example, the systems and techniques described herein may aid a device in securely establishing connections (e.g., selecting a secure network to connect to) and/or dynamically selecting secure clouds for processing data (e.g., selecting a cloud with security appropriate to a processing task).

For example, the systems and techniques may establish WiFi connections securely. For instance, a device implementing or including the systems and techniques may intend to establish a wireless connection with a wireless network. The device may not have connected to the network before. As such a security status or capability of the network may be unknown to the device. Before connecting to the network, the device may check for alerts from nearby devices. For example, other devices including or implementing the systems and techniques may have previously detected issues with the network and may broadcast (e.g., using a network that is different from any of the possible wireless networks, such as a network associated with sideband communications according to Bluetooth^{TM} protocols, mmWave, UWB protocols, and/or other protocols) alerts regarding the network. Additionally or alternatively, the nearby devices may be repeating previously-broadcast alerts regarding the network. If the device has received alerts regarding the network, the device may forego connecting to the network. Additionally or alternatively, the device may repeat the alerts.

Additionally or alternatively, a device including or implementing the systems and techniques may connect to a network. The device may determine that there is a security issue with the network. The device may broadcast (e.g., using sideband communications, such as according to Bluetooth™ protocols, mmWave, and/or UWB protocols) an alert regarding the network to other devices.

In some aspects, a wireless access point (WAP) (e.g., a router) implementing the systems and techniques may broadcast, along with an identifier, a count of devices connected to a network associated with the WAP. For example, a WAP may broadcast a network identifier (e.g., service set identifier (SSID)) such that wireless devices may connect to the network. Along with the identifier, the WAP may broadcast a count of the number of devices currently connected to the network such that devices that may connect to the network can determine whether to connect to the network based on the count of the number of devices currently connected to the network.

According to various aspects of the present disclosure, a device implementing the systems and techniques may display a count of the number of devices connected to a network with an identifier of the network to a user such that the user may select a network based on count of the number of devices connected to the network. A user may infer security of a network and/or congestion of the network based on the count of the number of devices currently connected to the network. For example, a large number of devices connected to a network may indicate that many other users trust the network. Additionally, a large number of devices connected to a network may indicate that the network may be congested.

In some aspects, a device implementing the systems and techniques may have access to images of an environment of the device. For example, the device may include one or more scene-facing cameras that may capture images of the environment of the device. The systems and techniques may detect, in the images, information regarding a network. For example, the systems and techniques may detect an identifier (e.g., SSID) of a network and/or a password associated with the network. For instance, an operator or owner of a public space may provide free access to the internet via a wireless network in the public space. The public space may include signs displaying a network identifier and/or password such that users in the space may identify the network and connect to it.

According to various aspects of the present disclosure, the systems and techniques may cause a device to display information regarding networks to which the device may connect. A user of the device may provide a user input indicating a network to connect to, and the device may connect to the network. When displaying the information regarding the networks, the systems and techniques may display a list of networks. Further, the systems and techniques may enrich the list of networks and display the enriched list. In the present disclosure, the term “enrich” may refer to providing additional information along with an identifier of a network. Enriching may be done by coloring network identifiers, adding a colored background or highlighting to network identifiers, adding icons, characters, or numbers alongside network identifiers, ordering a list of network identifiers, etc. The enrichment may convey related to a trustworthiness of networks and/or a number of devices connected to a network.

As an example, if a device including or implementing the systems and techniques has received an alert regarding a network, the device may display an identifier of the network in red or beside a warning icon. As another example, if the device has received an indication of a count of a number of devices connected to a network, the device may display an indication of the count beside a network identifier of the network. Additionally or alternatively, if the count is within a threshold range, the device may display an icon or may color the network identifier. As yet another example, if the systems and techniques have detected a network identifier in images on an environment of the device, the device may display the network identifier in green or beside a safe icon.

Additionally or alternatively, the systems and techniques may group similar network identifiers. In some instances, bad actors may create unsafe networks in public places. The bad actors may name the unsafe networks with names that mimic names of networks already in the public places. For example, there may be a network with the SSID “LAX Free Public Wi-Fi” in the Los Angeles airport. A bad actor may deploy a network with the SSID “_LAX Free WiFi” in the airport as well. The systems and techniques may generate a list of available wireless networks. The systems and techniques may compare each network identifiers of the list with the other network identifiers of the list and group similar network identifiers together in an enriched list for display to a user. The user may then see similar network identifiers together and may be better able to select a safe network. For example, if the SSIDs “LAX Free Public Wi-Fi” and “_LAX Free WiFi” were listed alphabetically (which may be the default of many devices), a user may see “_LAX Free WiFi” early in the list and may not see or notice “LAX Free Public Wi-Fi.” However, the systems and techniques may group “LAX Free Public Wi-Fi” and “_LAX Free WiFi” and display “LAX Free Public Wi-Fi” and “_LAX Free WiFi” together (e.g., beside each other) in the list of enriched network identifiers.

According to various aspects of the present disclosure, the systems and techniques may dynamically select secure cloud networks. There may be private, confidential clouds which may be owned and/or operated by the user or a trusted party (e.g., the user's employer). In some cases, the user's employer may not trust a cloud trusted by the user. For example, a user may trust a cloud to store their personal photos, however the user's employer may not want photos captured on company property stored in the same cloud. There may be public clouds which may be owned and operated by untrusted parties (e.g., other companies). Some users may trust public clouds to process personal data (e.g., to store photos or respond to queries). However, an employer may not want company proprietary data to be processed by a public cloud.

The systems and techniques may determine a context in which a device is operating. Further the systems and techniques may determine a confidentiality level associated with the context. Additionally or alternatively, the systems and techniques may determine a confidentiality level of data that is to be processed. Based on the confidentiality of the context and/or of the data, the systems and techniques may select a service, cloud, or model for processing the data. For example, the systems and techniques may select between a private, confidential cloud and a third-party cloud, etc.

The status of clouds (whether private, confidential, etc.) may vary over time. The systems and techniques may obtain updates regarding the cloud and select clouds based on up-to-date information regarding the confidentiality of the clouds.

Various aspects of the application will be described with respect to the figures below.

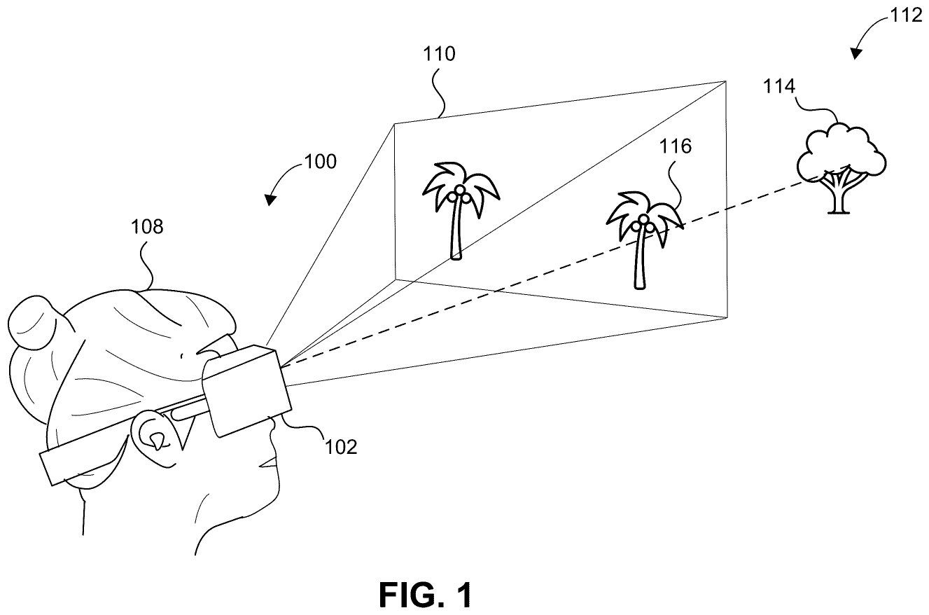

FIG. 1 is a diagram illustrating an example extended-reality (XR) system 100, according to aspects of the disclosure. As shown, XR system 100 includes an XR device 102. XR device 102 may implement, as examples, image-capture, object-detection, object-tracking, gaze-tracking, view-tracking, localization (e.g., determining a location of XR device 102), pose-tracking (e.g., tracking a pose of XR device 102 and/or a pose of one or more objects in scene 112), content-generation, content-rendering, computational, communicational, and/or display aspects of extended reality, including virtual reality (VR), augmented reality (AR), and/or mixed reality (MR).

For example, XR device 102 may include one or more scene-facing cameras that may capture images of a scene 112 in which a user 108 uses XR device 102. XR device 102 may detect and/or track objects (e.g., object 114) in scene 112 based on the images of scene 112. In some aspects, XR device 102 may include one or more user-facing cameras that may capture images of eyes of user 108. XR device 102 may determine a gaze of user 108 based on the images of user 108. In some aspects, XR device 102 may determine an object of interest (e.g., object 114) in scene 112 (e.g., based on the gaze of user 108, based on object recognition, and/or based on a received indication regarding object 114). XR device 102 may obtain and/or render XR content 116 (e.g., text, images, and/or video) for display at XR device 102. XR device 102 may display XR content 116 to user 108 (e.g., within a field of view 110 of user 108). In some aspects, XR content 116 may be based on and/or anchored to points in scene 112. For example, XR content 116 may be, or may include, an altered version of object 114 (e.g., based on an XR application running at XR device 102) anchored to object 114 in scene 112. The XR application may provide user 108 with an XR experience by altering scene 112 in view 110 of user 108. In some aspects, XR device 102 may display XR content 116 in relation to the view of user 108 of the object of interest. For example, XR device 102 may overlay XR content 116 onto object 114 in field of view 110. In any case, XR device 102 may overlay XR content 116 (whether related to object 114 or not) onto the view of user 108 of scene 112. For example, object 114 may be a cherry tree. Based on an XR application running at XR device 102, XR device 102 may anchor XR content 116, which may be a palm tree, to object 114 such that in the view of user 108, user 108 sees XR content 116 (the palm tree) and not object 114 (the cherry tree).

In a “see-through” or “transparent” configuration, XR device 102 may include a transparent surface (e.g., optical glass) such that XR content 116 may be displayed on (e.g., by being projected onto) the transparent surface to overlay the view of user 108 of scene 112 as viewed through the transparent surface. In a “pass-through” configuration or a “video see-through” configuration, XR device 102 may include a scene-facing camera that may capture images of scene 112. XR device 102 may display images or video of scene 112, as captured by the scene-facing camera, and XR content 116 overlaid on the images or video of scene 112.

In various examples, XR device 102 may be, or may include, a head-mounted device (HMD), a virtual reality headset, and/or smart glasses. XR device 102 may include one or more cameras, including scene-facing cameras and/or user-facing cameras, a GPU, one or more sensors (e.g., such as one or more inertial measurement units (IMUs), image sensors, and/or microphones), one or more communication units (e.g., wireless communication units), and/or one or more output devices (e.g., such as speakers, headphones, display, and/or smart glass).

In some aspects, XR device 102 may be, or may include, two or more devices. For example, XR device 102 may include a display device and a processing device. The display device may capture and/or generate data, such as image data (e.g., from user-facing cameras and/or scene-facing cameras) and/or motion data (from an inertial measurement unit (IMU)). The display device may provide the data to the processing device, for example, through a wireless connection between the display device and the processing device. The processing device may process the data and/or other data (e.g., data received from another source). Further, the processing unit may generate (or obtain) XR content 116 to be displayed at the display device. The processing device may provide the generated XR content 116 to the display device, for example, through the wireless connection. And the display device may display XR content 116 in field of view 110 of user 108.

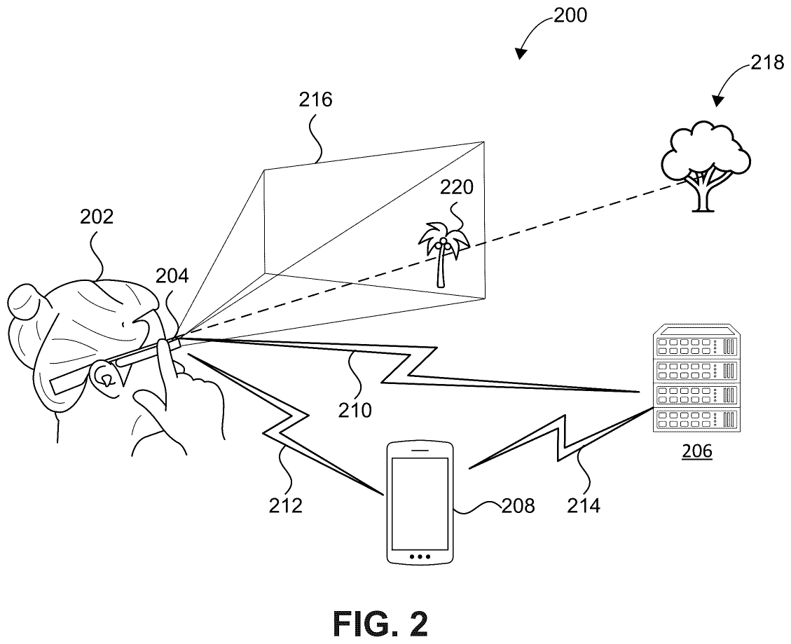

FIG. 2 is a diagram illustrating an example extended reality (XR) system 200, according to aspects of the disclosure. In some aspects, an XR system may be, or may include, two or more devices. The two or more devices of XR system 200 may perform the operations described with regard to XR system 100 of FIG. 1.

For example, XR system 200 includes a display device 204 and a processing device 206. In some aspects, display device 204 and processing device 206 may implement a communication link 210 between display device 204 and processing device 206. Communication link 210 may be a wireless connection according to any suitable wireless protocol, such as, a broadband-cellular-network protocol, for example, a fifth generation (5G) wireless cellular protocol.

In some aspects, XR system 200 may include a companion device 208. Display device 204 and companion device 208 and may implement a communication link 212 between display device 204 and companion device 208 and companion device 208 and processing device 206 may implement a communication link 214 between companion device 208 and processing device 206. Communication link 212 may be a wireless connection according to any suitable wireless protocol, such as, for example, Institute of Electrical and Electronics Engineers (IEEE) 802.11 (Wi-Fi), IEEE 802.15, or Bluetooth®. Communication link 214 may be a wireless connection according to any suitable wireless protocol, such as, a broadband-cellular-network protocol, for example, a fifth generation (5G) wireless cellular protocol.

Display device 204, processing device 206, and/or companion device 208 may collectively implement as examples, image-capture, object-detection, object-tracking, gaze-tracking, view-tracking, localization, pose-tracking, content-generation, content-rendering, computational, communicational, and/or display aspects of XR. For example, display device 204 may implement image-capture, gaze-tracking, view-tracking, localization, pose-tracking, communicational, and/or display aspects of XR. Processing device 206 may implement object-detection, object-tracking, localization, content-generation, content-rendering, computational, and/or communicational, aspects of XR. Additionally or alternatively, companion device 208 may implement at least a portion of one or more of localization, pose-tracking, communicational, object-detection, object-tracking, localization, content-generation, content-rendering, and/or computational aspects of XR.

For example, display device 204 may capture and/or generate data, such as image data (e.g., from user-facing cameras and/or scene-facing cameras) and/or motion data (from an inertial measurement unit (IMU)). Display device 204 may provide the data to processing device 206, for example, through communication link 210 or through communication link 212, companion device 208, and communication link 214.

Processing device 206 may process the data and/or other data (e.g., data received from another source or data stored at processing device 206). For example, processing device 206 may detect, recognize, and/or track objects in scene 218 based on the images of scene 218. Further, processing device 206 may generate (or obtain) XR content 220 to be rendered for display at display device 204. Processing device 206 may render XR content 220 to be appropriate for display at display device 204 (e.g., based on a pose of display device 204). Processing device 206 may provide rendered XR content 220 to display device 204 through communication link 210 (or communication link 214, companion device 208, and communication link 212) and display device 204 may display XR content 220 in field of view 216 of user 202.

In various examples, display device 204 may be, or may include, a head-mounted display (HMD), a virtual reality headset, and/or smart glasses. Display device 204 may include one or more cameras, including scene-facing cameras and/or user-facing cameras, a GPU, one or more sensors (e.g., such as one or more inertial measurement units (IMUs), image sensors, and/or microphones), and/or one or more output devices (e.g., such as speakers, headphones, displays, and/or smart glass). In other examples, display device 204 may include a handheld device with a display, such as a smartphone or tablet.

Processing device 206 may be, or may include, for example, a server computer (e.g., an edge or cloud-based server, a personal computer acting as a server device, or a mobile device acting as a server device). Processing device 206 may be configured to store virtual content and/or perform operations related to rendering the virtual content as image data suitable for providing to display device 204 for display. Companion device 208 may be, or may include, a smartphone, laptop, tablet computer, personal computer, gaming system, any other computing device and/or a combination thereof.

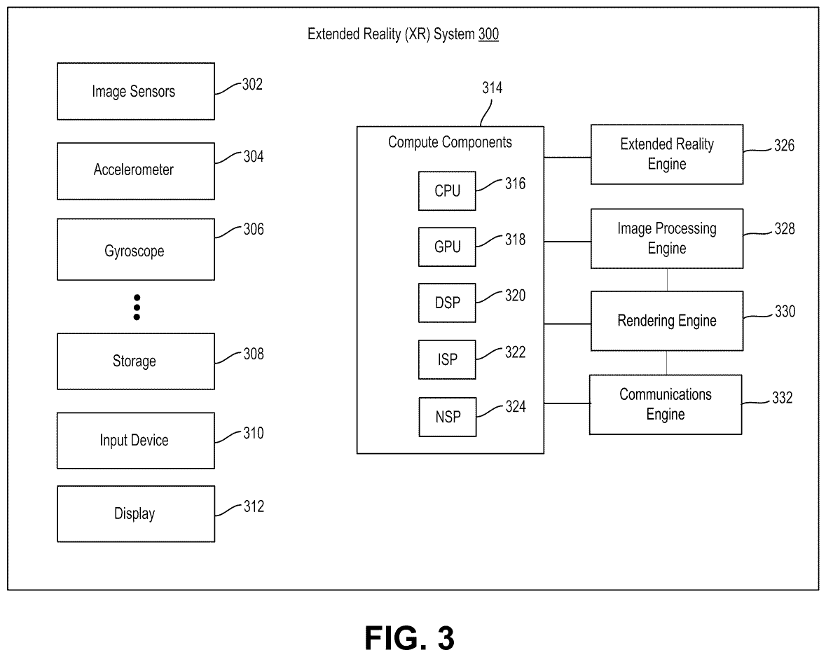

FIG. 3 is a diagram illustrating an architecture of an example extended reality (XR) system 300, in accordance with some aspects of the disclosure. XR system 300 may execute XR applications and implement XR operations.

In this illustrative example, XR system 300 includes one or more image sensors 302, an accelerometer 304, a gyroscope 306, storage 308, an input device 310, a display 312, Compute components 314, an XR engine 326, an image processing engine 328, a rendering engine 330, and a communications engine 332. It should be noted that the components 302-332 shown in FIG. 3 are non-limiting examples provided for illustrative and explanation purposes, and other examples may include more, fewer, or different components than those shown in FIG. 3. For example, in some cases, XR system 300 may include one or more other sensors (e.g., one or more inertial measurement units (IMUs), radars, light detection and ranging (LIDAR) sensors, radio detection and ranging (RADAR) sensors, sound detection and ranging (SODAR) sensors, sound navigation and ranging (SONAR) sensors, audio sensors, etc.), one or more display devices, one more other processing engines, one or more other hardware components, and/or one or more other software and/or hardware components that are not shown in FIG. 3. While various components of XR system 300, such as image sensor 302, may be referenced in the singular form herein, it should be understood that XR system 300 may include multiple of any component discussed herein (e.g., multiple image sensors 302).

Display 312 may be, or may include, a glass, a screen, a lens, a projector, and/or other display mechanism that allows a user to see the real-world environment and also allows XR content to be overlaid, overlapped, blended with, or otherwise displayed thereon.

XR system 300 may include, or may be in communication with, (wired or wirelessly) an input device 310. Input device 310 may include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device discussed herein, or any combination thereof. In some cases, image sensor 302 may capture images that may be processed for interpreting gesture commands.

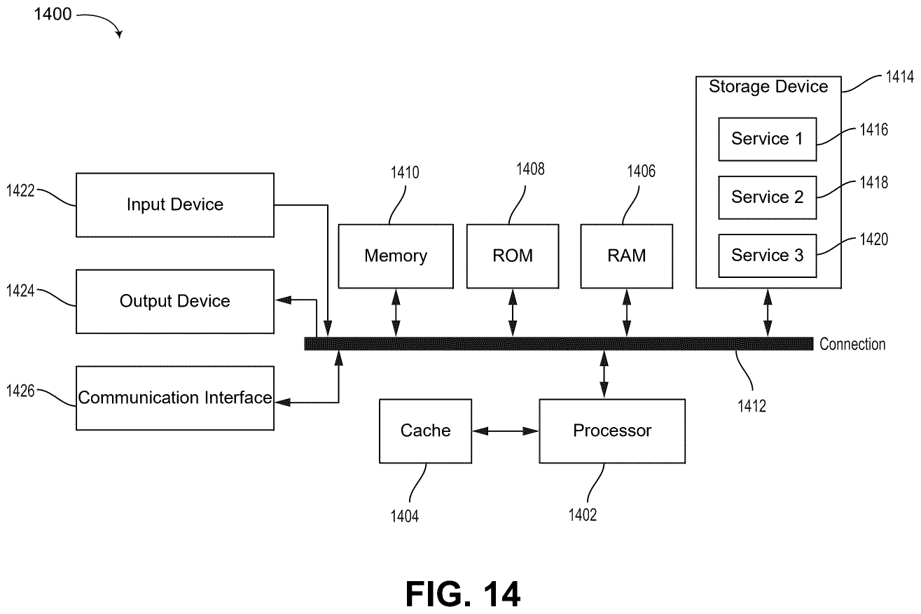

XR system 300 may also communicate with one or more other electronic devices (wired or wirelessly). For example, communications engine 332 may be configured to manage connections and communicate with one or more electronic devices. In some cases, communications engine 332 may correspond to communication interface 1426 of FIG. 14.

In some implementations, image sensors 302, accelerometer 304, gyroscope 306, storage 308, display 312, compute components 314, XR engine 326, image processing engine 328, and rendering engine 330 may be part of the same computing device. For example, in some cases, image sensors 302, accelerometer 304, gyroscope 306, storage 308, display 312, compute components 314, XR engine 326, image processing engine 328, and rendering engine 330 may be integrated into an HMD, extended reality glasses, smartphone, laptop, tablet computer, gaming system, and/or any other computing device. However, in some implementations, image sensors 302, accelerometer 304, gyroscope 306, storage 308, display 312, compute components 314, XR engine 326, image processing engine 328, and rendering engine 330 may be part of two or more separate computing devices. For instance, in some cases, some of the components 302-332 may be part of, or implemented by, one computing device and the remaining components may be part of, or implemented by, one or more other computing devices. For example, such as in a split perception XR system, XR system 300 may include a first device (e.g., an HMD), including display 312, image sensor 302, accelerometer 304, gyroscope 306, and/or one or more compute components 314. XR system 300 may also include a second device including additional compute components 314 (e.g., implementing XR engine 326, image processing engine 328, rendering engine 330, and/or communications engine 332). In such an example, the second device may generate virtual content based on information or data (e.g., images, sensor data such as measurements from accelerometer 304 and gyroscope 306) and may provide the virtual content to the first device for display at the first device. The second device may be, or may include, a smartphone, laptop, tablet computer, personal computer, gaming system, a server computer or server device (e.g., an edge or cloud-based server, a personal computer acting as a server device, or a mobile device acting as a server device), any other computing device and/or a combination thereof.

Storage 308 may be any storage device(s) for storing data. Moreover, storage 308 may store data from any of the components of XR system 300. For example, storage 308 may store data from image sensor 302 (e.g., image or video data), data from accelerometer 304 (e.g., measurements), data from gyroscope 306 (e.g., measurements), data from compute components 314 (e.g., processing parameters, preferences, virtual content, rendering content, scene maps, tracking and localization data, object detection data, privacy data, XR application data, face recognition data, occlusion data, etc.), data from XR engine 326, data from image processing engine 328, and/or data from rendering engine 330 (e.g., output frames). In some examples, storage 308 may include a buffer for storing frames for processing by compute components 314.

Compute components 314 may be, or may include, a central processing unit (CPU) 316, a graphics processing unit (GPU) 318, a digital signal processor (DSP) 320, an image signal processor (ISP) 322, a neural processing unit (NPU) 324, which may implement one or more trained neural networks, and/or other processors. Compute components 314 may perform various operations such as image enhancement, computer vision (CV), graphics rendering, extended reality operations (e.g., tracking, localization, pose estimation, mapping, content anchoring, content rendering, predicting, etc.), image and/or video processing, sensor processing, recognition (e.g., text recognition, facial recognition, object recognition, feature recognition, tracking or pattern recognition, scene recognition, occlusion detection, etc.), trained machine-learning operations, filtering, and/or any of the various operations described herein. In some examples, compute components 314 may implement (e.g., control, operate, etc.) XR engine 326, image processing engine 328, and rendering engine 330. In other examples, compute components 314 may also implement one or more other processing engines.

Image sensor 302 may include any image and/or video sensors or capturing devices. In some examples, image sensor 302 may be part of a multiple-camera assembly, such as a dual-camera assembly. Image sensor 302 may capture image and/or video content (e.g., raw image and/or video data), which may then be processed by compute components 314, XR engine 326, image processing engine 328, and/or rendering engine 330 as described herein.

In some examples, image sensor 302 may capture image data and may generate images (also referred to as frames) based on the image data and/or may provide the image data or frames to XR engine 326, image processing engine 328, and/or rendering engine 330 for processing. An image or frame may include a video frame of a video sequence or a still image. An image or frame may include a pixel array representing a scene. For example, an image may be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, image sensor 302 (and/or other camera of XR system 300) may be configured to also capture depth information. For example, in some implementations, image sensor 302 (and/or other camera) may include an RGB-depth (RGB-D) camera. In some cases, XR system 300 may include one or more depth sensors (not shown) that are separate from image sensor 302 (and/or other camera) and that may capture depth information. For instance, such a depth sensor may obtain depth information independently from image sensor 302. In some examples, a depth sensor may be physically installed in the same general location or position as image sensor 302 but may operate at a different frequency or frame rate from image sensor 302. In some examples, a depth sensor may take the form of a light source that may project a structured or textured light pattern, which may include one or more narrow bands of light, onto one or more objects in a scene. Depth information may then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

XR system 300 may also include other sensors in its one or more sensors. The one or more sensors may include one or more accelerometers (e.g., accelerometer 304), one or more gyroscopes (e.g., gyroscope 306), and/or other sensors. The one or more sensors may provide velocity, orientation, and/or other position-related information to compute components 314. For example, accelerometer 304 may detect acceleration by XR system 300 and may generate acceleration measurements based on the detected acceleration. In some cases, accelerometer 304 may provide one or more translational vectors (e.g., up/down, left/right, forward/back) that may be used for determining a position or pose of XR system 300. Gyroscope 306 may detect and measure the orientation and angular velocity of XR system 300. For example, gyroscope 306 may be used to measure the pitch, roll, and yaw of XR system 300. In some cases, gyroscope 306 may provide one or more rotational vectors (e.g., pitch, yaw, roll). In some examples, image sensor 302 and/or XR engine 326 may use measurements obtained by accelerometer 304 (e.g., one or more translational vectors) and/or gyroscope 306 (e.g., one or more rotational vectors) to calculate the pose of XR system 300. As previously noted, in other examples, XR system 300 may also include other sensors, such as a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors may include at least one IMU. An IMU is an electronic device that measures the specific force, angular rate, and/or the orientation of XR system 300, using a combination of one or more accelerometers, one or more gyroscopes, and/or one or more magnetometers. For example, an IMU of XR system 300 may include accelerometer 304, gyroscope 306, and/or a magnetometer. In some examples, the one or more sensors may output measured information associated with the capture of an image captured by image sensor 302 (and/or other camera of XR system 300) and/or depth information obtained using one or more depth sensors of XR system 300.

The output of one or more sensors (e.g., accelerometer 304, gyroscope 306, and/or other sensors) can be used by XR engine 326 to determine a pose of XR system 300 (also referred to as the head pose) and/or the pose of image sensor 302 (or other camera of XR system 300). In some cases, the pose of XR system 300 and the pose of image sensor 302 (or other camera) can be the same. The pose of image sensor 302 refers to the position and orientation of image sensor 302 relative to a frame of reference (e.g., with respect to a field of view 110 of FIG. 1). In some implementations, the camera pose can be determined for 6-Degrees of Freedom (6 DoF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference). In some implementations, the camera pose can be determined for 3-Degrees of Freedom (3 DoF), which refers to the three angular components (e.g. roll, pitch, and yaw).

In some cases, a device tracker (not shown) can use the measurements from the one or more sensors and image data from image sensor 302 to track a pose (e.g., a 6 DoF pose) of XR system 300. For example, the device tracker can fuse visual data (e.g., using a visual tracking solution) from the image data with inertial data from the measurements to determine a position and motion of XR system 300 relative to the physical world (e.g., the scene) and a map of the physical world. As described below, in some examples, when tracking the pose of XR system 300, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of XR system 300 within the scene and the 3D map of the scene, etc. The 3D map can provide a digital representation of a scene in the real/physical world. In some examples, the 3D map can anchor position-based objects and/or content to real-world coordinates and/or objects. XR system 300 can use a mapped scene (e.g., a scene in the physical world represented by, and/or associated with, a 3D map) to merge the physical and virtual worlds and/or merge virtual content or objects with the physical environment.

In some aspects, the pose of image sensor 302 and/or XR system 300 as a whole can be determined and/or tracked by compute components 314 using a visual tracking solution based on images captured by image sensor 302 (and/or other camera of XR system 300). For instance, in some examples, compute components 314 can perform tracking using computer vision-based tracking, model-based tracking, and/or simultaneous localization and mapping (SLAM) techniques. For instance, compute components 314 can perform SLAM or can be in communication (wired or wireless) with a SLAM system (not shown). SLAM refers to a class of techniques where a map of an environment (e.g., a map of an environment being modeled by XR system 300) is created while simultaneously tracking the pose of a camera (e.g., image sensor 302) and/or XR system 300 relative to that map. The map can be referred to as a SLAM map which can be three-dimensional (3D). The SLAM techniques can be performed using color or grayscale image data captured by image sensor 302 (and/or other camera of XR system 300) and can be used to generate estimates of 6 DoF pose measurements of image sensor 302 and/or XR system 300. Such a SLAM technique configured to perform 6 DoF tracking can be referred to as 6 DoF SLAM. In some cases, the output of the one or more sensors (e.g., accelerometer 304, gyroscope 306, and/or other sensors) can be used to estimate, correct, and/or otherwise adjust the estimated pose.

In some cases, the 6 DoF SLAM (e.g., 6 DoF tracking) can associate features observed from certain input images from the image sensor 302 (and/or other camera) to the SLAM map. For example, 6 DoF SLAM can use feature point associations from an input image to determine the pose (position and orientation) of the image sensor 302 and/or XR system 300 for the input image. 6 DoF mapping can also be performed to update the SLAM map. In some cases, the SLAM map maintained using the 6 DoF SLAM can contain 3D feature points triangulated from two or more images. For example, key frames can be selected from input images or a video stream to represent an observed scene. For every key frame, a respective 6 DoF camera pose associated with the image can be determined. The pose of the image sensor 302 and/or the XR system 300 can be determined by projecting features from the 3D SLAM map into an image or video frame and updating the camera pose from verified 2D-3D correspondences.

In one illustrative example, the compute components 314 can extract feature points from certain input images (e.g., every input image, a subset of the input images, etc.) or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The feature points in key frames either match (are the same or correspond to) or fail to match the feature points of previously-captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Learned Invariant Feature Transform (LIFT), Speed Up Robust Features (SURF), Gradient Location-Orientation histogram (GLOH), Oriented Fast and Rotated Brief (ORB), Binary Robust Invariant Scalable Keypoints (BRISK), Fast Retina Keypoint (FREAK), KAZE, Accelerated KAZE (AKAZE), Normalized Cross Correlation (NCC), descriptor matching, another suitable technique, or a combination thereof.

As one illustrative example, the compute components 314 can extract feature points corresponding to a mobile device, or the like. In some cases, feature points corresponding to the mobile device can be tracked to determine a pose of the mobile device. As described in more detail below, the pose of the mobile device can be used to determine a location for projection of AR media content that can enhance media content displayed on a display of the mobile device.

In some cases, the XR system 300 can also track the hand and/or fingers of the user to allow the user to interact with and/or control virtual content in a virtual environment. For example, the XR system 300 can track a pose and/or movement of the hand and/or fingertips of the user to identify or translate user interactions with the virtual environment. The user interactions can include, for example and without limitation, moving an item of virtual content, resizing the item of virtual content, selecting an input interface element in a virtual user interface (e.g., a virtual representation of a mobile phone, a virtual keyboard, and/or other virtual interface), providing an input through a virtual user interface, etc.

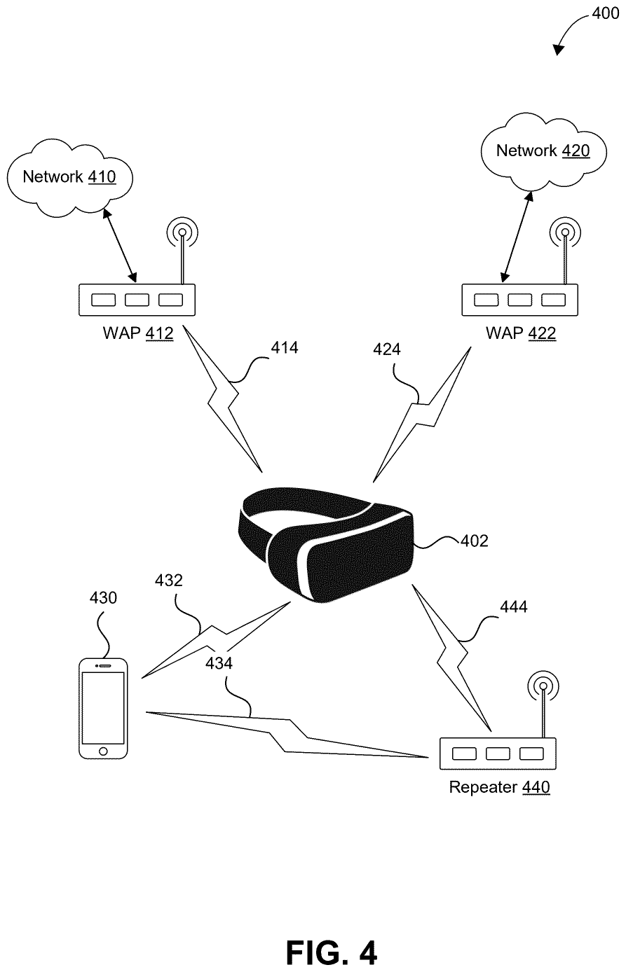

FIG. 4 is a diagram representing an example environment 400 in which a device 402 may select a network with which to connect, according to various aspects of the present disclosure. For example, device 402 may be in environment 400. Wireless access point (WAP) 412 and WAP 422 may be in or near environment 400. WAP 412 may advertise network 410 (e.g., broadcast a network identifier, such as a service set identifier (SSID) of network 410). WAP 412 may allow device 402 to establish a connection 414 with WAP 412 and thereby connect device 402 to network 410. Similarly, WAP 422 may advertise and enable a connection 424 with network 420.

Device 402 may be, or may include, a device capable of wireless communications, including communicating with remote computing devices, such as through a computing network (e.g., network 410 or network 420). Device 402 may be, for example, an XR device, a smartphone, a tablet, a laptop, etc. Device 402 may implement the systems and techniques to determine a network with which to connect.

Network 410 and network 420 may be, or may include, any number of interconnected computing devices. Network 410 and/or network 420 may be connected to the internet. For example, device 402 may be able to connect to the internet via network 410 or network 420. Additionally or alternatively, network 410 and/or network 420 may provide access to one or more clouds (e.g., services associated with network 410 or the internet generally).

WAP 412 and WAP 422 may be, or may include, electronic computing devices capable of enabling communications between device 402 and network 410 and network 420 respectively. For example, WAP 412 and WAP 422 may be routers. WAP 412 and WAP 422 may implement networking protocols, such as Institute of Electrical and Electronics Engineers (IEEE) 802.11 (WiFi) protocols, Address Resolution Protocol (ARP), Hypertext Transfer Protocol (HTTP), Internet Protocol (IP), Simple Mail Transfer Protocol (SMTP), Transport Control Protocol (TCP), User Datagram Protocol (UDP), Border Gateway Protocol (BGP), Open Shortest Path First (OSPF), Domain Name System (DNS), Dynamic Host Configuration Protocol (DHCP), File Transfer Protocol (FTP), Internet Control Message Protocol (ICMP), Simple Network Management Protocol (SNMP) and Telnet.

Connection 414 represents a potential wireless communicative connection between device 402 and WAP 412 (e.g., through which device 402 may communicate with computing devices of, or in communication with, network 410). Connection 424 represents a potential wireless communicative connection between device 402 and WAP 422 (e.g., through which device 402 may communicate with computing devices of, or in communication with, network 420). Connection 414 and connection 424 may be potential, for example, at a given time, device 402 may connect to WAP 412 via connection 414, additionally or alternatively, device 402 may connect with WAP 422 via connection 424. Initially, device 402 may not be connected to either of WAP 412 or WAP 422 and there may be no connection 414 and connection 424. Connection 414 and connection 424 may be according to a WiFi protocol.

Device(s) 430 is representative of one or more other devices that may be present in environment 400 and/or have information regarding network 410 and/or network 420. Device(s) 430 may be, or may include, one or more XR devices, one or more smartphones, one or more tablets, one or more laptops, etc.

Device(s) 430 may be capable of transmitting sideband communications 432 to device 402 over a network that is different from any of the possible wireless networks to which the device 402 is attempting to connect. For instance, sideband communications 432 may be according to Bluetooth™ protocols, millimeter wave (mmWave) protocols, optical communication (e.g., visible light, infrared etc.) and/or ultra-wideband (UWB) protocols, among others.

Repeater 440 may be, or may include, a networking device capable of broadcasting messages. Repeater 440 may be, for example, a router, a network extender, a network repeater etc. Repeater 440 may be configured to broadcast (e.g., at a pre-determined regularity) message 444. Message 444 may be a message according to a protocol of repeater 440 (e.g., a WiFi protocol).

According to various aspects of the present disclosure, device 402 may establish WiFi connections securely. For example, device 402 may select a network to which to connect based on a determine security of the select network.

If a user of device 402 has a companion device (e.g., a smartphone) that has a connection to a cellular network (e.g., a broadband-cellular-network connection), device 402 may connect to the internet via the companion device by default.

In some aspects, device(s) 430 may have information regarding network 410 and/or network 420. For example, device(s) 430 may have connected to network 410 and determined that network 410 is unsafe. For instance, device(s) 430 may have connected to network 410 and attempted to connect to the internet and failed. As another example, device(s) 430 may have connected to network 410, then searched online for information regarding network 410 and received information indicating that network 410 is unsafe.

Device(s) 430 may transmit (e.g., broadcast) sideband communications 432 including information regarding network 410 and/or network 420. If device 402 receives sideband communications 432 indicating that network 410 is unsafe, device 402 may determine to not connect to network 410. Additionally or alternatively, device 402 may display information to a user of device 402 indicating that network 410 is suspicious. In some aspects, device 402 may rebroadcast sideband communications 432, for example, such that others of device(s) 430 may receive sideband communications 432 and be alerted regarding network 410.

Additionally or alternatively, device(s) 430 may transmit message 434 to repeater 440. Repeater 440 may rebroadcast connection 424 as message 444 (e.g., at a pre-determined regularity). In some aspects, repeater 440 may aggregate messages from device(s) 430 and message 444 may include a summary or digest of reported suspicious networks. If device 402 receives message 444 indicating that network 410 is unsafe, device 402 may determine to not connect to network 410. Additionally or alternatively, device 402 may display information to a user of device 402 indicating that network 410 is suspicious.

Additionally or alternatively, device 402 may connect to network 410 (e.g., in the absence of, or despite, indications that network 410 is unsafe). Network 410 may test a security of network 410. For example, device 402 may attempt to connect to a remote computing device via network 410 and download data. If device 402 is unable to connect to the internet and download the data, device 402 may determine that network 410 is unsafe. Additionally or alternatively, once connected to network 410, device 402 may perform a search (e.g., of a database, the internet, a blog related to known bad, or good, networks, or a repository of known bad networks) for network 410. If results of the search indicate that network 410 is unsafe, device 402 may determine that network 410 is unsafe.

If device 402 determines that network 410 is unsafe, device 402 may broadcast sideband communications 432 indicating that network 410 is unsafe. Additionally or alternatively, device 402 may transmit message 444 to repeater 440 indicating that network 410 is unsafe. Sideband communications 432 and/or message 444 may alert other device(s) 430 that network 410 is unsafe. Additionally or alternatively, device 402 may connect to a safe network (e.g., network 420) then transmit a message via network 420 indicating that network 410 is unsafe.

According to various aspects of the present disclosure, WAP 412 and/or WAP 422 may broadcast, along with respective identifiers of network 410 and network 420, a count of devices connected to network 410 and network 420 respectively. For example, network 410 may broadcast a network identifier (e.g., service set identifier (SSID)) of network 410 such that device 402 may connect to network 410. Along with the identifier, WAP 412 may broadcast a count of the number of devices currently connected to network 410 such that device 402 can determine whether to connect to network 410 based on the count of the number of devices currently connected to network 410.

Device 402 may display an indication of the count of the number of devices connected to network 410 with the network identifier of network 410 to a user such that the user may select a network to connect to based on count of the number of devices connected to the network. For example, WAP 412 may broadcast a count of the number of devices connected to network 410. WAP 422 may broadcast a count of the number of devices connected to network 420. Device 402 may display a network identifier of network 410 alongside the count of the number of devices connected to network 410 and a network identifier of network 420 alongside the count of the number of devices connected to network 420.

A user of device 402 may infer security of a network and/or congestion of network 410 based on the count of the number of devices currently connected to network 410. For example, a large number of devices connected to network 410 may indicate that many other users trust network 410. Additionally, a large number of devices connected to network 410 may indicate that network 410 may be congested and may provide slow service.

In some aspects, device 402 may have access to images captured in environment 400. For example, device 402 may include one or more scene-facing cameras that may capture images of environment 400.

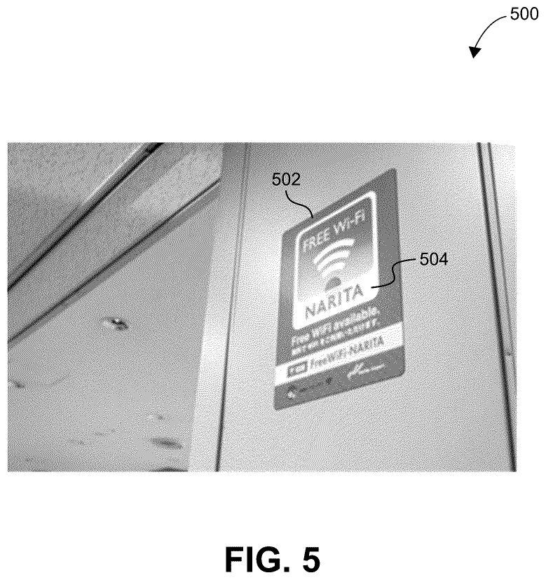

FIG. 5 includes an example image 500, that may be a cropped portion of an image, captured in environment 400 (e.g., by device 402). Device 402 may detect, in image 500, information regarding a network. For example, device 402 may detect network identifier 504 of a network (e.g., network 420) and/or a password associated with the network. For instance, an operator or owner of environment 400 may provide free access to the internet via network 420. The owner or operator of environment 400 may place sign 502 (which may display a network identifier 504 and/or password) in environment 400 such that users in environment 400 may identify network 420 and connect to network 420.

Returning to FIG. 4, device 402 may display information regarding networks (e.g., network 410 and network 420) to which device 402 may connect. A user of device 402 may provide a user input indicating a network to which to connect (e.g., a selection of network 410 or network 420). Device 402 may connect to the selected network.

For example, device 402 may obtain network identifiers of corresponding networks. For instance, device 402 may receive an advertisement from WAP 412 including a network identifier of network 410 and an advertisement from WAP 422 including a network identifier of network 420. Device 402 may generate a list of the network identifiers.

Device 402 may enrich the list to generate an enriched list and display the enriched list to the user. For example, device 402 may add a colored background or highlighting to network identifiers of the enriched list, add icons, characters, or numbers alongside network identifiers of the enriched list, order the network identifiers in the enriched list, etc. The enrichment may convey related to a trustworthiness of networks and/or a number of devices connected to a network.

As an example, if device 402 has received an alert (e.g., in sideband communications 432 and/or message 444) regarding a network (e.g., network 410), device 402 may display a network identifier of the network in red or beside a warning icon in the enriched list. As another example, if device 402 has received an indication of a count of a number of devices connected to a network, device 402 may display an indication of the count beside a network identifier of the network in the enriched list. Additionally or alternatively, if the count is within a threshold range, the device may display an icon or may color the network identifier in the enriched list. As yet another example, if device 402 has detected a network identifier in images on environment 400 (e.g., on sign 502), device 402 may display the network identifier in green or beside a safe icon.

Additionally or alternatively, device 402 may group similar network identifiers. In some instances, bad actors may create unsafe networks in public places. The bad actors may name the unsafe networks with names that mimic names of networks already in the public places. For example, there may be a network with the SSID “LAX Free Public Wi-Fi” in the Los Angeles airport. A bad actor may deploy a network with the SSID “_LAX Free WiFi” in the airport as well. Device 402 may generate a list of available wireless networks. device 402 may compare each network identifiers of the list with the other network identifiers of the list and group similar network identifiers together in the enriched list for display to a user. The user may then see similar network identifiers together and may be better able to select a safe network. For example, if the SSIDs “LAX Free Public Wi-Fi” and “_LAX Free WiFi” were listed alphabetically (which may be the default of many devices), a user may see “_LAX Free WiFi” early in the list and may not see or notice “LAX Free Public Wi-Fi.” However, the systems and techniques may group “LAX Free Public Wi-Fi” and “_LAX Free WiFi” and display “LAX Free Public Wi-Fi” and “_LAX Free WiFi” together (e.g., beside each other) in the list of enriched network identifiers.

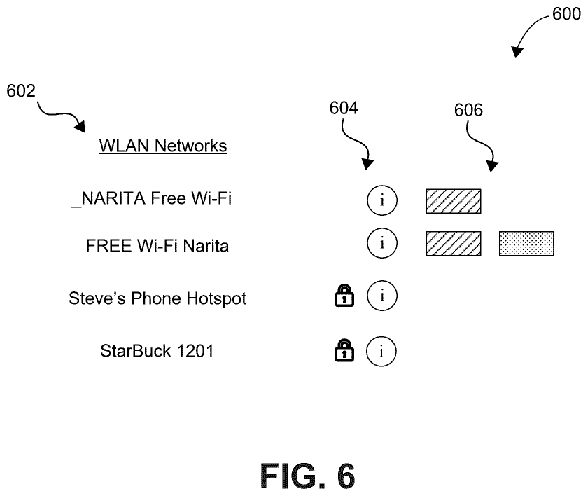

FIG. 6 includes an example enriched list 600, generated according to various aspects of the present disclosure. Enriched list 600 includes list 602 of network identifiers, icons 604, and different indicators 606 (e.g., patterns, colors, etc.). List 602 may be ordered based on similarities between network identifiers of list 602. For example, similar network identifiers of list 602 may be listed together. For example, “LAX Free Public Wi-Fi” and “_LAX Free WiFi” may be listed together.

In some aspects, to determine the similarity between network identifiers of list 602, device 402 may implement a machine-learning model trained to identify similar strings in a list of strings. The machine-learning model may be, or may include, a small language model (SLM). The SLM may be a large language model (LLM) trained or conditioned for a specific task. Additionally or alternatively, device 402 may include a text analyzer that may determine a similarity between network identifiers based on text-based rules (e.g., the text including similar characters).

Additionally, enriched list 600 includes icons 604. Icons 604 may indicate information regarding a security of networks associated with the respective network identifiers of list 602. For example, a lock icon may indicate that the network associated with the network identifier beside the icon is protected by a password. An “i” icon may indicate that device 402 has additional information regarding the network associated with the network identifier beside the icon. A “!” icon may indicate that the network is suspicious (e.g., based on an alert regarding the network).

Additionally or alternatively, enriched list 600 includes indicators 606. Indicators 606 may include patterns, colors, and/or other indicators used to display network identifiers of list 602. For example, the text of list 602 may be displayed in different colors. Alternatively, the network identifiers may be highlighted by the colors. Additionally or alternatively, icons may be displayed in the colors. Additionally or alternatively, the colors may be displayed as an icon (e.g., a shape in the color) among or beside icons 604.

Certain colors, such as red and orange, may indicate that a network associated with network identifiers displayed in the certain colors is suspicious. Other colors, such as green or blue, may indicate that a network associated with network identifiers displayed in the certain colors is less suspicious.

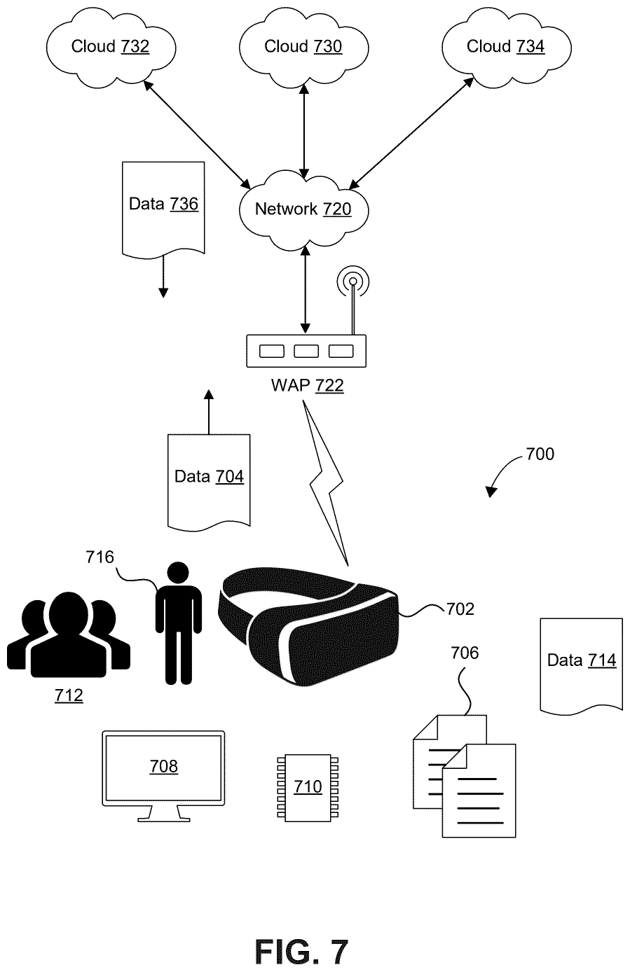

FIG. 7 is a diagram representing an example environment 700 in which a device 702 may select a cloud to process data 704, according to various aspects of the present disclosure. For example, device 702 may intend to transmit data 704 to a cloud for the cloud to process data 704. Device 702 may determine to which cloud to transmit data 704.

Device 702 may be the same as, may be substantially similar to, and/or may perform the same, or substantially the same, operations as device 402 of FIG. 4. Additionally, device 702 may generate data 704 and determine to transmit data 704 to a cloud for processing and/or storage. For example, device 702 may transmit data 704 to a cloud for the cloud to process and/or store data 704 (and in some cases, return data 736 to device 702). Device 702 may transmit data 704 to the cloud to conserve power, processing time, storage, etc. of device 702. As examples, user 716 may request a service that is performed in a cloud, such as summarizing a document using a large language model (LLM), responding to a query using an LLM, translating words, detecting objects in an image using a large vision model (LVM), rendering data to display at device 702, and/or storing photos in remote storage.

Data 704 may be, or may include, data that device 702 sends to a cloud to be processed. Data 704 may be, or may include, image data (e.g., images captured by device 702), audio data (e.g., audio data recorded by device 702), text data (e.g., queries, text to summarize or translate etc.), numerical data, etc.

Documents 706 is an example of material (e.g., printed material) that may be in environment 700. Some instances of documents 706 may include company confidential information (CCI). Displays 708 is an example of a display in environment 700. Sometimes displays 708 may display CCI. Object 710 is an example of an object in environment 700. Object 710 may represent CCI, for example, object 710 may be associated with a trade secret or confidential invention.

People 712 may include people in environment 700. In some situations, images of people 712 or audio recorded of people 712 may be sensitive. For example, there may be privacy laws prohibiting public distribution of images of people 712 without the consent of people 712. As another example, people 712 may be performing confidential processes. Data 714 is an example of digital data that may be transmitted to device 702 while device 702 is in environment 700. For example, data 714 may include messages (e.g., emails, instant messages, texts, etc.) that may be transmitted to device 702. In some aspects, data 714 may include CCI.

In some cases, device 702 may generate data 704 based on environment 700. For example, device 702 may capture images of environment 700 and/or capture audio in environment 700. As such, in some cases, data 704 may include representations of documents 706, displays 708, object 710 and/or people 712. Additionally or alternatively, device 702 may request processing of data 704 based on data 714. Because any or all of documents 706, displays 708, object 710, people 712 and data 714 may be sensitive and/or confidential, data 704 may be sensitive or confidential and it may be important that device 702 select an appropriate cloud to process data 704.

Network 720 may be the same as, may be substantially similar to, and/or may perform the same, or substantially the same, operations as network 410 and/or network 420 of FIG. 4. WAP 722 may be the same as, may be substantially similar to, and/or may perform the same, or substantially the same, operations as WAP 412 and/or WAP 422 of FIG. 4.

Cloud 730, cloud 732 and cloud 734 are examples of computing systems that may perform operations at the request of device 702. For example, any of cloud 730, cloud 732, and/or cloud 734 may process data 704 to generate data 736. Further, the one of cloud 730, cloud 732, and/or cloud 734 that processed data 704 may transmit data 736 to device 702. Additionally or alternatively, any of cloud 730, cloud 732, and/or cloud 734 may store data 704 and/or data 736. Examples of operations that may be performed by cloud 730, cloud 732, and/or cloud 734 include: summarizing documents, responding to queries, translating text, translating audio, detecting objects in images, storing images, storing audio, summarizing audio, identifying something and providing an indication of the identified something (e.g., allowing an XR headset to highlight an identified portion of text in the view of user 716), etc. Cloud 730, cloud 732, and/or cloud 734 may operate on image data (e.g., data 704 may be, or may include, image data captured by device 702 in environment 700, such as images of documents 706, displays 708, object 710, and/or people 712), audio data, (e.g., data 704 may be, or may include, audio data captured by device 702 in environment 700), video data (e.g., data 704 may be, or may include, video data captured by device 702 in environment 700), text data, numerical data, and/or other data (e.g., data 704 may be, or may include, data 714 and/or a subset of data 714).

Cloud 730, cloud 732, and cloud 734 may have different levels of security and/or confidentiality. For example, cloud 730 may be a company cloud which may be owned and/or operated by an employer of user 716. Cloud 732 may be a personal cloud which may be owned and/or operated by user 716. User 716 may not want personal data to be stored and/or processed by cloud 730. Similarly, an employer of user 716 may not want CCI processed and/or stored by cloud 732. Cloud 734 may be a public cloud, which may not be owned and/or operated by an employer of user 716 or by user 716. Data processed by cloud 734 may be accessible to the owner of cloud 734. User 716 and/or the employer of user 716 may not want the owners and/or operators of cloud 734 to have access to personal data and/or CCI.

Device 702 may determine a confidentiality level associated with data 704. In some aspects, device 702 may determine the confidentiality level of data 704 based on environment 700 (e.g., based on data 704 being captured, recorded, generated, received, while device 702 is in environment 700). For instance, based on image data, audio data, geolocation data, and/or calendar data, device 702 may classify environment 700. For example, based on image data captured by device 702 including company logos, company color schemes, company posters, keywords, and/or quick response (QR) codes, device 702 may determine that environment 700 is work environment. As another example, based on image data captured by device 702 including objects associated with a home of user 716, device 702 may classify environment 700 as a home environment. As yet another example, based on image data captured by device 702 including many people, an outdoor environment, a recognizable landmark, device 702 may determine that environment 700 is a public environment. As another example, based on geolocation data (e.g., determined by a geolocation service, such as a global positioning system (GPS) service of device 702), device 702 may determine that environment 700 is a home of user 716, a place of work of user 716, or a public environment. As another example, based on a calendar of a user of device 702 and a current time, device 702 may determine that environment 700 is a home of user 716, a place of work of user 716, or a public environment.

Device 702 may include a machine-learning model trained to classify environments based on image data, audio data, geolocation data, etc. Device 702 may classify environment 700 as: a workplace (e.g., which may be associated with a high level of confidentiality), a home (e.g., which may be associated with a personal level of confidentiality), a home office (which may be associated with two or more levels of confidentiality) a public place (e.g., which may be associated with a low level of confidentiality). Device 702 may determine that data 704 generated, captured, recorded, received, and/or obtained in environment 700 may be associated with the confidentiality level of environment 700.

Having classified environment 700, device 702 may determine a confidentiality of data 704 based on the classification of environment 700. For example, device 702 may determine that data 704 matches a strictest security level associated with environment 700.

Additionally or alternatively, may determine a confidentiality level of data 704 based on a content of data 704 and/or a context of data 704 (e.g., based on image data, audio data, and/or a source of data 714). For example, device 702 may capture images of documents 706, displays 708, object 710, and/or people 712. Device 702 may analyze the images. If the images include a security indicator (e.g., a company logo, a CCI label, a QR code, a specific watermark, etc.) device 702 may determine that images of documents 706, displays 708, object 710, and/or people 712 have a high level of confidentiality. Additionally or alternatively, device 702 may analyze text in images captured by device 702 (and/or text of data 714) to determine if the text includes CCI. Device 702 may also analyze image data captured by device 702 to determine if object 710 and/or people 712 are confidential, are performing confidential operations, etc. As another example, device 702 may analyze audio data captured by device 702. Device 702 may analyze words spoken and/or other sounds to determine if the audio data includes CCI (e.g., based on keywords associated with CCI).

In some aspects, device 702 may store a confidentiality level of data 704 and apply the stored confidentiality level to additional data. For example, device 702 may determine a confidentiality level of data 704. Device 702 may apply the confidentiality level of data 704 to all other data that device 702 obtains for a predetermined duration of time, while device 702 is in environment 700, during a calendar event, and/or to similar categories of data (for example, device 702 may apply the same confidentiality level to all image data captured for the next hour). After the predetermined duration of time, when device 702 leaves environment 700, after the end of the calendar event, or when another criteria is satisfied, device 702 may determine a new confidentiality level of additional data.

After determining a confidentiality level of data 704, device 702 may determine a security protocol for data 704 based on the confidentiality level of data 704. For example, if device 702 determines that data 704 is confidential, company information, device 702 may determine a high, company-only security protocol for data 704. Further, device 702 may determine to transmit data 704 to a cloud for processing based on the security protocol. For instance, device 702 may select a cloud from two or more clouds and transmit data 704 to the selected cloud for processing. For example, if device 702 determines a high, company-only security protocol for data 704, device 702 may determine to send data 704 to cloud 730 (e.g., a company cloud).

In some aspects, according to the security protocol, device 702 may encrypt data 704 prior to sending data 704 to a cloud for processing and/or storage. Further, device 702 may select an encryption protocol for encrypting data 704 based on the security protocol. Additionally or alternatively, device 702 may select a communication protocol for transmitting data 704 based on the security protocol. Further, device 702 may encrypt data 704 according to the selected encryption protocol. Further still, device 702 may transmit data 704 to the selected one of cloud 730, cloud 732, and cloud 734 according to the selected communication protocol.

In some aspects, when transmitting data 704 to a cloud, device 702 may transmit instructions for processing data 704. In some aspects, device 702 may determine the instructions based, at least in part, on the selected security protocol. For example, cloud 730 may be capable of processing data 704 at varying levels of confidentiality. Device 702 may indicate how data 704 is to be processed based on the confidentiality level of data 704.

The status of clouds (whether private, confidential, etc.) may vary over time. The device 702 may obtain updates regarding cloud 730, cloud 732, and cloud 734 such that device 702 is able to transmit data 704 to the appropriate cloud based on the confidentiality level of data 704.

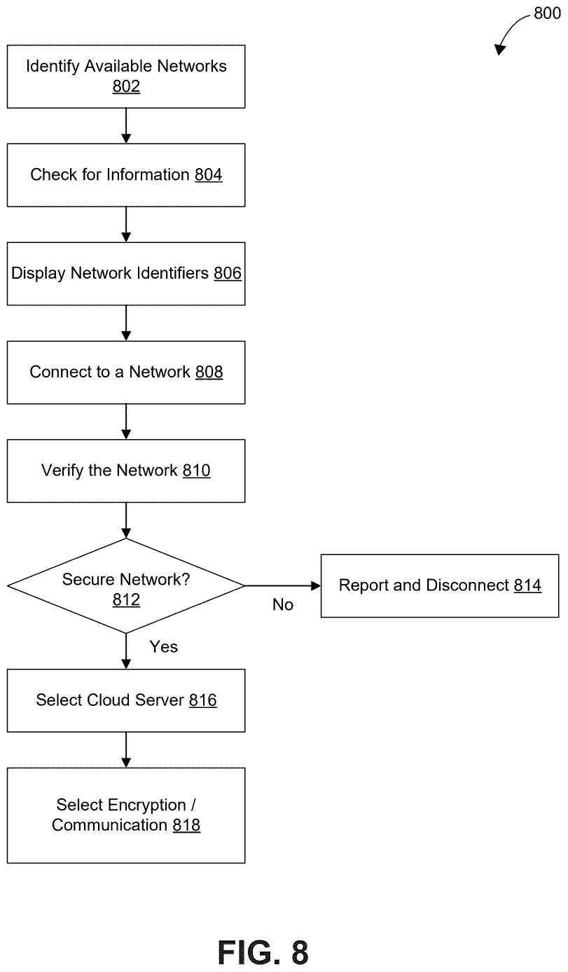

FIG. 8 is a flow diagram illustrating an example process 800 for wireless communications, in accordance with aspects of the present disclosure. One or more operations of process 800 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 800. The one or more operations of process 800 may be implemented as software components that are executed and run on one or more processors.

At block 802, a computing device (and/or one or more component thereof) (e.g., device 402 of FIG. 4 or device 702 of FIG. 7) may identify available networks. For example, as described with regard to FIG. 4, device 402 may receive advertisements from multiple networks (e.g., network 410 and network 420).

At block 804, the computing device (and/or one or more component thereof) may check for information regarding the identified networks. For example, as described with regard to FIG. 4, device 402 may check received alerts to see if any of the networks identified at block 802 are the subject of any alerts (e.g., in sideband communications 432 and/or message 444) that have been received by device 402. Additionally, as described with regard to FIG. 4 and FIG. 5, device 402 may check to see if device 402 has obtained images including information (e.g., a network identifier) regarding any of the identified networks. Additionally, as described with regard to FIG. 4, device 402 may check to see if device 402 has received a count of devices connected to any of the identified networks.

At block 806, the computing device (and/or one or more component thereof) may display network identifiers of the networks identified at block 802. For example, as described with regard to FIG. 4 and FIG. 6, device 402 may display network identifiers (e.g., in an enriched list including coloring, icons, numbers, etc.).

A user may select a network identifier from among the displayed network identifiers. At block 808, the computing device (and/or one or more component thereof) may connect to the selected network.

At block 810, the computing device (and/or one or more component thereof) may verify the network to which the computing device (and/or one or more component thereof) connected to at block 808. For example, as described with regard to FIG. 4, device 402 may connect to a remote computing device via the network. Additionally or alternatively, device 402 may perform a search regarding the network.

At decision block 812 it may be determined whether the network connected to at block 808 is secure or not. If the network connected to at block 808 is insecure, process 800 may proceed to block 814. If the network is secure, process 800 may proceed to block 816.

At block 814, the computing device (and/or one or more component thereof) may disconnect from the network connected to at block 808. For example, as described with regard to FIG. 4, if device 402 determines that network 410 is insecure, device 402 may disconnect from network 410. Additionally, the computing device (and/or one or more component thereof) may report the insecurity of the network. For example, as described with regard to FIG. 4, device 402 may report its determination regarding network 410 (e.g., through sideband communications 432 and/or message 444). In some aspects, device 402 may use network 410 to report the insecurity of network 410 before disconnecting from network 410.

At block 816, the computing device (and/or one or more component thereof) may select a cloud server to process data. For example, as described with regard to FIG. 7, device 702 may determine a confidentiality level of data to be processed by a cloud. Additionally, device 702 may determine a confidentiality associated with one or more clouds (e.g., cloud 730, cloud 732, and cloud 734). Device 702 may determine to which cloud to send data for processing. For example, device 702 may determine to which of cloud 730, cloud 732, or cloud 734 to send data 704.

At block 818, the computing device (and/or one or more component thereof) may select an encryption protocol and/or a communication protocol for sending the data. For example, as described with regard to FIG. 7, device 702 may determine an encryption protocol and/or a communication protocol for encrypting and communicating data 704. Further, device 702 may encrypt data 704 according to the selected encryption protocol. Further still, device 702 may transmit data 704 to the selected one of cloud 730, cloud 732, and cloud 734 according to the selected communication protocol.

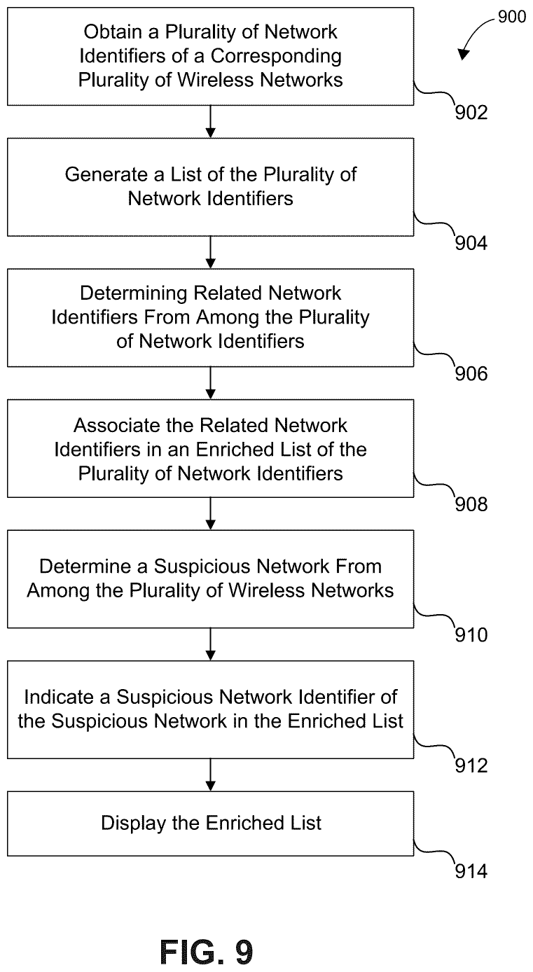

FIG. 9 is a flow diagram illustrating an example process 900 for wireless communications, in accordance with aspects of the present disclosure. One or more operations of process 900 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 900. The one or more operations of process 900 may be implemented as software components that are executed and run on one or more processors.

At block 902, a computing device (or one or more components thereof) may obtain a plurality of network identifiers of a corresponding plurality of wireless networks. For example, device 402 may receive a network identifier from WAP 412 and a network identifier from WAP 422.

At block 904, the computing device (or one or more components thereof) may generate a list of the plurality of network identifiers. For example, device 402 may generate a list of network identifiers received at block 902.

At block 906, the computing device (or one or more components thereof) may determine related network identifiers from among the plurality of network identifiers. for example, device 402 may determine related network identifiers from among the network identifiers obtained at block 902.

At block 908, the computing device (or one or more components thereof) may associate the related network identifiers in an enriched list of the plurality of network identifiers. For example, device 402 may associate related network identifiers. For instance, device 402 may group related network identifiers, such as in list 602.

At block 910, the computing device (or one or more components thereof) may determine a suspicious network from among the plurality of wireless networks. For example, device 402 may determine that “_NARITA Free Wi-Fi” is suspicious.

In some aspects, the suspicious network is determined based on a message received from another device, and wherein the message is received over a network that is different from the plurality of wireless networks. For example, device 402 may obtain a message from device(s) 430 via sideband communications 432. The message may indicate that “_NARITA Free Wi-Fi” is suspicious.

In some aspects, to determine the suspicious network, the computing device (or one or more components thereof) may identify the suspicious network identifier based on text-based rules; identify the suspicious network identifier by performing a search for the suspicious network identifier; and/or process the related network identifiers using a machine-learning model trained to identify the suspicious network identifier. For example, device 402 may determine that “_NARITA Free Wi-Fi” is suspicious based on text-based rules (e.g., rules about special characters, such as “_”). Additionally or alternatively, device 402 may determine that “_NARITA Free Wi-Fi” is suspicious based on a search (e.g., an internet search for “_NARITA Free Wi-Fi.” Additionally or alternatively, device 402 may determine that “_NARITA Free Wi-Fi” is suspicious by using a machine-learning model trained to identify suspicious network identifiers.

At block 912, the computing device (or one or more components thereof) may indicate a suspicious network identifier of the suspicious network in the enriched list. For example, device 402 may indicate that “_NARITA Free Wi-Fi” is suspicious, for instance by displaying “_NARITA Free Wi-Fi” in a color or beside an icon.

In some aspects, the computing device (or one or more components thereof) may detect an indication of a trustworthy network in an image of an environment of the device; and indicate a network identifier of the trustworthy network in the enriched list. For example, device 402 may capture images an environment of device 402 (e.g., image 500). In some cases, device 402 may detect an indication that a network identifier is trustworthy in the images. For example, image 500 may include a sign 502 indicating a network identifier of a trustworthy network.

At block 914, the computing device (or one or more components thereof) may display the enriched list. For example, device 402 may display list 602.

In some aspects, the computing device (or one or more components thereof) may obtain a user input indicative of a network identifier of the plurality of network identifiers; connect the device to a wireless network of the plurality of wireless networks that corresponds to the network identifier; test a security of the wireless network; and in response to a failed security test, disconnect from the wireless network and broadcasting a message indicating the failed security test of the wireless network. For example, device 402 may obtain a user input indicating a network identifier of the displayed network identifiers. For instance, a user may provide an input to device 402 indicating that the user has determined to connect to network 410. Device 402 may connect to network 410. Device 402 may test a security of network 410. In response to a failed security text, device 402 may disconnect from network 410 and broadcast a messages indicating that network 410 failed the security test. Device 402 may broadcast the message via sideband communications.

In some aspects, to broadcast the message, the computing device (or one or more components thereof) may connect to an additional wireless network of the plurality of wireless networks; and cause at least one transmitter to transmit the message to a networking device of the additional wireless network. For example, device 402 may connect to network 420 and broadcast a message regarding the failed security test of network 410 via network 420.

In some aspects, to test the security of the wireless network, computing device (or one or more components thereof) may connect to a remote computing device via the wireless network; and receive data from the remote computing device; or perform a search based on the network identifier of the wireless network. For example, device 402 may connect to a remote computing device via network 410 and attempt to obtain a file from the remote computing device. Additionally or alternatively, device 402 may perform a search (e.g., an internet search) for a network identifier of network 410.

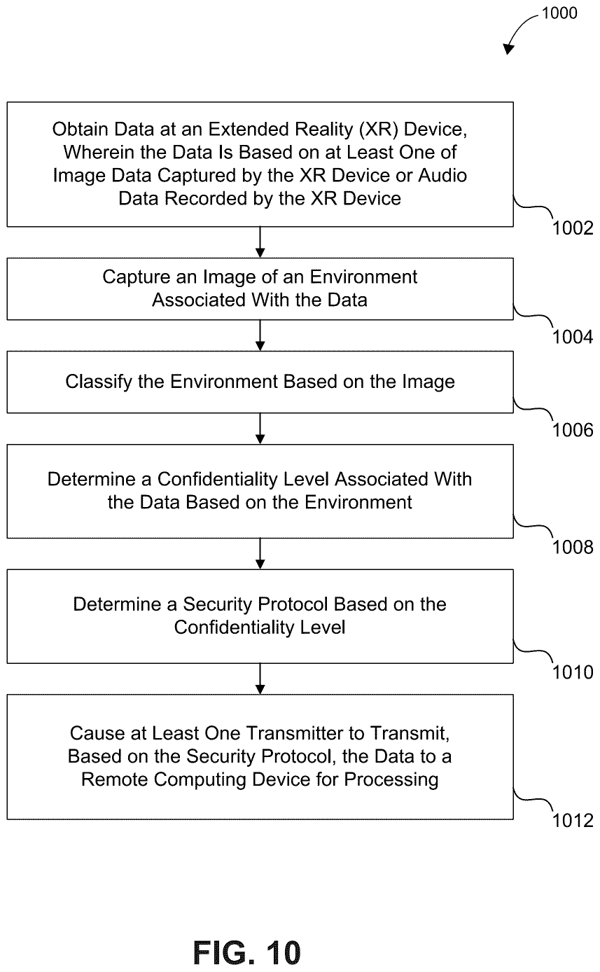

FIG. 10 is a flow diagram illustrating an example process 1000 for wireless communications, in accordance with aspects of the present disclosure. One or more operations of process 1000 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1000. The one or more operations of process 1000 may be implemented as software components that are executed and run on one or more processors.

At block 1002, a computing device (or one or more components thereof) may obtain data at an extended reality (XR) device, wherein the data is based on at least one of image data captured by the XR device or audio data recorded by the XR device. For example, device 702 may obtain data (e.g., based on image data and/or audio data captured by device 702).

At block 1004, the computing device (or one or more components thereof) may capture an image of an environment associated with the data. For example, device 702 may capture an image of environment 700 (e.g., environment 700 in which the data was obtained at block 1002).

At block 1006, the computing device (or one or more components thereof) may classify the environment based on the image. For example, device 702 may classify environment 700.

At block 1008, the computing device (or one or more components thereof) may determine a confidentiality level associated with the data based on the environment. For example, device 702 may determine a confidentiality level associated with the data obtained at block 1002 based on the confidentiality level associated with environment 700 (e.g., as determined at block 1006).

In some aspects, the confidentiality level is determined based on at least one of: a location associated with the data; a time associated with the data; a calendar of a user of the XR device; an environment associated with the data; or content of the data. For example, device 702 may determine the confidentiality level of the data a location of environment 700, a time the data was captured, a calendar of user 716, environment 700, and/or content of the data.

In some aspects, the computing device (or one or more components thereof) may capture an image of a representation of the data; and classify the data based on the image; wherein the confidentiality level is determined further based on the classification of the data. For example, device 702 may capture an image including a representation of the data (e.g., as documents 706, displayed on displays 708, as object 710, etc.). Device 702 may determine the confidentiality level of the data based on the image of the data.

In some aspects, to classify the data based on the image, the computing device (or one or more components thereof) may detect a security indicator comprising at least one of keywords, a watermark, a quick response (QR) code, or a company confidential information (CCI) label in the image; and classify the data based on the security indicator. For example, device 702 may detect a QR code, watermark, CCI label etc. in images of the data.

At block 1010, the computing device (or one or more components thereof) may determine a security protocol based on the confidentiality level. For example, device 702 may determine a security protocol based on the confidentiality level associated with the data.

At block 1012, the computing device (or one or more components thereof) may cause at least one transmitter to transmit, based on the security protocol, the data to a remote computing device for processing. For example, device 702 may transmit data 704 to one of cloud 732, cloud 730, or cloud 734 for processing.

In some aspects, the computing device (or one or more components thereof) may store the confidentiality level; and apply the confidentiality level to other data, wherein the confidentiality level is applied to the other data based on the other data being obtained at least one of: at a related location; at a related time; or in association with a related calendar event. For example, device 702 may store the confidentiality level and apply the stored confidentiality level to additional data obtained in environment 700, additional data obtained within a time window, etc.

In some aspects, to cause at least one transmitter to transmit, based on the security protocol, the data to the remote computing device for processing, the computing device (or one or more components thereof) may determine to transmit the data to a remote computing device from among two or more remote computing devices based on the security protocol. For example, device 702 may determine which one of cloud 730, cloud 732 or cloud 734 to transmit data 704 to for processing.

In some aspects, to cause at least one transmitter to transmit, based on the security protocol, the data to the remote computing device for processing, the computing device (or one or more components thereof) may determine an encryption protocol from among two or more encryption protocols based on the security protocol; and encrypt the data according to the encryption protocol prior to transmitting the data; determine a secure communication protocol from among two or more communication protocols based on the security protocol; and cause at least one transmitter to transmit the data to the remote computing device according to the secure communication protocol; or cause at least one transmitter to transmit the data with an instruction regarding how the data is to be processed, wherein the instruction is based on the security protocol.

For example, device 702 may determine an encryption protocol based on the confidentiality level of data 704 and encrypt data 704 using the determined encryption protocol. As another example, device 702 may determine an secure communication protocol based on the confidentiality level of data 704 and transmit data 704 using the determined secure communication protocol. As an example, device 702 may transmit, with data 704, instructions regarding processing of data 704.

In some examples, as noted previously, the methods described herein (e.g., process 800 of FIG. 8, process 900 of FIG. 9, process 1000 of FIG. 10, and/or other methods described herein) can be performed, in whole or in part, by a computing device or apparatus. In one example, one or more of the methods can be performed by device 402 of FIG. 4, device(s) 430, of FIG. 4, device 702 of FIG. 7 or by another system or device. In another example, one or more of the methods (e.g., process 800, process 900, process 1000 and/or other methods described herein) can be performed, in whole or in part, by the computing-device architecture 1400 shown in FIG. 14. For instance, a computing device with the computing-device architecture 1400 shown in FIG. 14 can include, or be included in, the components of the device 402, device(s) 430, and/or device 702 and can implement the operations of process 800, process 900, process 1000, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 800, process 900, process 1000, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 800, process 900, process 1000, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

Machine learning systems (or models), such as neural networks (e.g., deep neural networks) are widely used for numerous applications, such as generative operations (e.g., to generate images, language/text outputs, etc.), object detection, object classification, object tracking, big data analysis, among others. For example, convolutional neural networks (CNNs) are able to extract high-level features, such as facial shapes, from an input image, and use these high-level features to output a probability that, for example, an input image includes a particular object.

A generative machine learning system can process data to generate desired output content from an input (e.g., a natural language input, input image(s) or video(s), a noise input such as for diffusion models, etc.). For instance, a language-based generative machine learning model (e.g., a large language model (LLM)) can generate natural language responses from natural language inputs and can incorporate various forms of data, such as audio, images and text. In some cases, a generative machine learning system can include an encoder that processes input features to generate output features (also referred to as embeddings or encodings) and can use the output features to generate relevant output content in a given form (e.g., in a natural language form, as generated images and/or video, as audio, explanation of the content, etc.).

A generative ML system can perform a wide range of tasks such as answering questions, providing explanations, generating creative content, assisting with coding, and offering recommendations. Various tools may be connected to the generative ML system to allow interaction with external systems, such as browsing the Internet, generating images, executing code, etc. Generative ML systems are designed to assist users in solving problems, learning new information, and enhancing productivity.

Machine learning models can be trained to perform various functions and/or provide various types of outputs. For instance, some generative machine learning models can provide a conversational interface that uses natural language prompts as inputs, such as text or voice. In some examples, a user can provide an input prompt in natural language to the generative machine learning model, and the generative machine learning model can provide a response in natural language form. The input prompt and the output response can optionally be combined with one or more other types of information or data, such as images or files.

Previously trained machine learning models, such as generative machine learning models, can be fine-tuned to improve performance of the machine learning models for specific tasks. Fine-tuning can involve adapting a pre-trained machine learning model (e.g., a pre-trained generative machine learning model or other type of machine learning model) to a specific task by updating parameters (e.g., weights and/or other parameters) of the machine learning model using task-specific training data. The fine-tuning process allows the machine learning model to leverage its pre-existing knowledge while specializing in new tasks. Fine-tuning typically requires less data and compute than fully training a previously untrained machine learning model. Fine-tuning can thus be useful for improving performance of machine learning models on domain-specific tasks without sacrificing the benefits of large-scale pretraining.

One technique for fine tuning machine learning models is to use an adapter, such as a Low-Rank Adapter (LoRA). An adapter is a lightweight trainable model that connects to different layers (or blocks) of a machine learning model (e.g., a first layer of one adapter connected to a first layer of the model, a second layer of the adapter connected to a second layer of the model, etc.). Adapters can be used to efficiently adapt large pre-trained models to specific tasks with minimal computational cost and resource usage. Adapters (e.g., a LoRA) can be trained to generalize task-specific information to a frozen (e.g., immutable) pre-trained machine learning model.

For instance, LoRA introduces lightweight trainable modules parameterized as low-rank matrices into an original (e.g., pre-trained) machine learning model to capture task-specific information while the original machine learning model parameters remain frozen, preserving the pre-trained knowledge of the machine learning model. Training a LoRA can include injecting low-rank layers into certain layers of the base model (e.g., attention layers in a transformer model, feedforward layers in the transformer model, convolutional layers in a transformer and/or convolutional model, etc.) to optimize the layers during training and reduce the number of overall parameters that need to be updated. LoRA can be used to efficiently adapt large pre-trained models to specific tasks with minimal computational cost and resource usage. For example, LoRA may be used to fine-tune a pre-trained model for downstream tasks, such as style adaptation, tone, etc. Such a technique can be performed to overcome the computational challenges of fine-tuning large machine learning models, such as when working with a smaller dataset.

While machine learning models (e.g., neural networks) are powerful architectures capable of a wide range of useful tasks, such as recognizing objects in image data, they are likewise highly resource dependent. For example, neural networks may require significant compute, memory, power, and/or time resources for training and/or for inferencing. These resource requirements may significantly limit the ability to train and deploy neural networks to certain types of devices and for certain use cases. For instance, training of machine learning models may be a computationally intensive process that ca take a relatively long time, a large quantity of training data, and many operations.

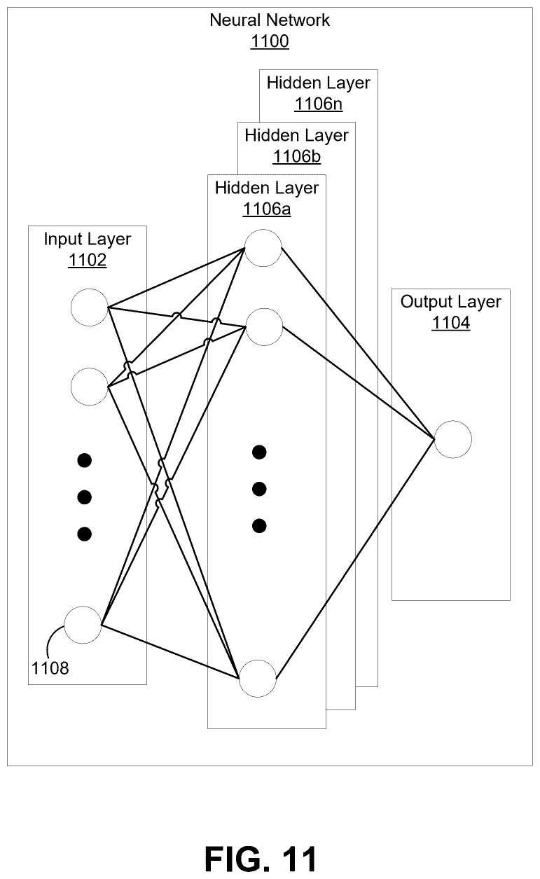

FIG. 11 is an illustrative example of a neural network 1100 (e.g., a deep-learning neural network) that can be used to implement machine-learning based feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 1100 may be implemented in a cloud, such as cloud 730, cloud 732, or cloud 734 of FIG. 7.

An input layer 1102 includes input data. In one illustrative example, input layer 1102 can include data representing data 704. Neural network 1100 includes multiple hidden layers, for example, hidden layers 1106a, 1106b, through 1106n. The hidden layers 1106a, 1106b, through hidden layer 1106n include “n” number of hidden layers, where “n” is an integer greater than or equal to one. The number of hidden layers can be made to include as many layers as needed for the given application. Neural network 1100 further includes an output layer 1104 that provides an output resulting from the processing performed by the hidden layers 1106a, 1106b, through 1106n. In one illustrative example, output layer 1104 can generate data 736.

Neural network 1100 may be, or may include, a multi-layer neural network of interconnected nodes. Each node can represent a piece of information. Information associated with the nodes is shared among the different layers and each layer retains information as information is processed. In some cases, neural network 1100 can include a feed-forward network, in which case there are no feedback connections where outputs of the network are fed back into itself. In some cases, neural network 1100 can include a recurrent neural network, which can have loops that allow information to be carried across nodes while reading in input.

Information can be exchanged between nodes through node-to-node interconnections between the various layers. Nodes of input layer 1102 can activate a set of nodes in the first hidden layer 1106a. For example, as shown, each of the input nodes of input layer 1102 is connected to each of the nodes of the first hidden layer 1106a. The nodes of first hidden layer 1106a can transform the information of each input node by applying activation functions to the input node information. The information derived from the transformation can then be passed to and can activate the nodes of the next hidden layer 1106b, which can perform their own designated functions. Example functions include convolutional, up-sampling, data transformation, and/or any other suitable functions. The output of the hidden layer 1106b can then activate nodes of the next hidden layer, and so on. The output of the last hidden layer 1106n can activate one or more nodes of the output layer 1104, at which an output is provided. In some cases, while nodes (e.g., node 1108) in neural network 1100 are shown as having multiple output lines, a node has a single output and all lines shown as being output from a node represent the same output value.

In some cases, each node or interconnection between nodes can have a weight that is a set of parameters derived from the training of neural network 1100. Once neural network 1100 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 1100 to be adaptive to inputs and able to learn as more and more data is processed.

Neural network 1100 may be pre-trained to process the features from the data in the input layer 1102 using the different hidden layers 1106a, 1106b, through 1106n in order to provide the output through the output layer 1104. In an example in which neural network 1100 is used to identify features in images, neural network 1100 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 1100 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 1100 is trained well enough so that the weights of the layers are accurately tuned.

For the example of identifying objects in images, the forward pass can include passing a training image through neural network 1100. The weights are initially randomized before neural network 1100 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 1100, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 1100 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½ (target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 1100 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−η dL/dW, where w denotes a weight, wᵢ denotes the initial weight, and η denotes a learning rate. The learning rate can be set to any suitable value, with a high learning rate including larger weight updates and a lower value indicating smaller weight updates.

Neural network 1100 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 1100 can include any other deep network other than a CNN, such as an autoencoder, a deep belief nets (DBNs), a Recurrent Neural Networks (RNNs), among others.

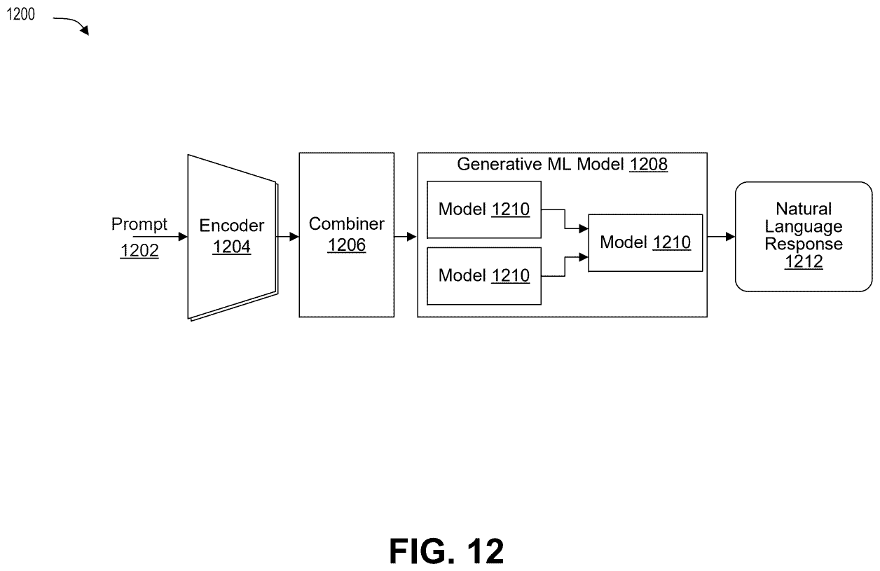

FIG. 12 is a block diagram illustrating a multimodal generative ML system 1200 for generating natural language responses based on natural language input from a prompt 1202 and any additional information. A multimodal machine learning system is a machine learning model that receives, processes, and outputs data in multiple forms. For example, the input prompt may include text, images, and audio. Multimodal generative ML system 1200 may be implemented in a cloud, such as cloud 730, cloud 732, or cloud 734 of FIG. 7.

For example, the multimodal generative ML system 1200 includes a plurality of encoders 1204 that are each configured to encode different modes of content (e.g., text, images, audio, etc.) into different tokens within a common embedding space. For example, a text input may be segmented based on different techniques (e.g., paragraph, sentence, etc.) and encoded by a text encoder (from the encoders 1204) into tokens. In another example, one or more images can be provided to an image encoder (from the encoders 1204) that extracts features associated with the image and generates tokens representing the visual features. In another example, audio can be provided to an audio encoder (from the encoders 1204) that extracts features associated with the image and generates tokens representing the audio features. In the case of audio, the audio encoder can identify features that can include formants that characterize resonant frequencies in speech, rhythmic features related to timing and tempo, and harmonic features that describe the relationship between fundamental frequencies and their harmonics.

The different tokens from the plurality of encoders are provided to combiner 1206. The combiner 1206 can combine the tokens based on the order in which they are presented. For example, the input into the encoder may be an array of primitive values. A primitive value is an immutable data type provided by a programming language and includes values that represent a single piece of data (e.g., number, string, Boolean, etc.) rather than a complex object or reference. A non-limiting example prompt may include a byte array (e.g., an unsigned 8-byte integer array or unit8array), and another string. The byte array may be audio, images, or other content that can be processed by the encoders 1204. In some aspects, the combiner 1206 is configured to concatenate the different tokens in order based on the array to preserve the semantic order of features and provide the tokens to the generative machine learning model 1208.

The generative machine learning model 1208 is configured to receive the tokens and generate a natural language response 1212 based on the tokens and the prompt 1202. Generative machine learning model 1208 may include one or more models 1210 (e.g., transformer neural network(s), diffusion model(s), fully connected layer(s), multilayer perceptrons (MLPs), any combination thereof, and/or other models). The one or more models 1210 of the generative machine learning model 1208 are configured to process the tokens and extract different types of features that are relevant to the prompt 1202. For example, the prompt 1202 can be a query for a particular type of information. The one or more models of the generative machine learning model 1208 can perform different tasks related to the query, such as writing code to perform a particular function, generating an image based on an input image with expressed modifications, generate an image without any input image, and so forth.

The generative machine learning model 1208 may include different components, such as a featurization engine to identify different types of features, an inference engine to identify inferences within the text (e.g., pronoun usage and corresponding disambiguation functions), data retrieval engines (e.g., to identify features related to a particular concept observed by the generative machine learning model 1208), and so forth. The generative machine learning model 1208 may also include different types of models and engines to synthesize a coherent contextual output, such as to synthesize the input content and information that is responsive to tasks embedded within the text. For example, the generative machine learning model 1208 may include a predictive output engine (not shown) that is configured to generate a sequence of words that is most likely contextually correct and to provide a coherent and contextually relevant answer. For instance, the predictive output generation engine can generate responses by sampling from the probability distribution of possible words and sequences based on patterns observed during training. The generative machine learning model 1208 may also include a predictive output generation engine to generate multiple responses that are potentially relevant and coherent with respect to the prompt 1202. The generative machine learning model 1208 may also include an output validation engine configured to evaluate the generated responses based on certain criteria. Non-limiting examples of criteria to evaluate generated responses include relevance to the prompt, coherence, fluency, and adherence to specific guidelines or rules. Based on the evaluation, the output validation engine may select and output the most appropriate response.

As noted above, the generative machine learning model 1208 may include various types of models (e.g., machine learning models), such as a transformer. A transformer is a neural network architecture that can be trained to perform one or more natural language processing (NLP) tasks, such as language translation, sentiment analysis, and text summarization. Conventional traditional recurrent neural networks (RNNs) process data in sequence. A transformer or transformer network can process input in parallel and can thus be faster and more efficient than sequential training and processing. In some aspects, a transformer can use a self-attention mechanism (e.g., one or more self-attention layers), which allows the transformer to identify the most relevant parts of the input text or content (e.g., audio or video). In some cases, a transformer can also use a cross-attention mechanism (e.g., one or more cross-attention layers) which uses other content or data to determine the most relevant parts of the input. For example, cross-attention mechanisms are useful in sequential content such as a stream of data, such as optical flow, and other computer vision techniques.

A transformer neural network can include a multi-layer encoder-decoder architecture. For instance, an encoder of the encoder-decoder architecture can receive text as input, convert the input text into a sequence of hidden representations, and capture the meaning of the text at different levels of abstraction. A decoder of the encoder-decoder architecture can then process the representations output from the decoder to generate an output sequence, such as a text translation or a summary. The encoder and decoder can be trained together using supervised learning, unsupervised learning, or a combination of supervised and unsupervised learning techniques, such as maximum likelihood estimation and self-supervised pretraining. Illustrative examples of transformer engines include a BERT model, a Text-to-Text Transfer Transformer (T5), biomedical BERT (BioBERT), scientific BERT (SciBERT), and the SPECTER model for document-level representation learning. In some aspects, multiple transformer engines may be used to generate different tokens.

In some aspects, the generative machine learning model 1208 may be executed using a neural engine (or multiple neural engines) for on-device execution, such as a neural processing unit (NPU), a neural signal processor (NSP), a digital signal processor (DSP), any combination thereof, and/or other neural engine. The neural engine can include a plurality of neural processing cores that are configured to parallelize operations associated with neural networks. A neural processing core can include arrays of multiply-accumulate (MAC) units and specialized instructions that are optimized for matrix operations, such as convolution and matrix multiplication. The neural processing core can receive input data and perform matrix transformations and nonlinear activation functions to break down and parallelize matrix operations. The neural processing core can perform tasks such as inference (e.g., runtime operation of a machine learning model) or training of deep learning models. The neural processing core can accelerate tasks by parallelization of larger computations that can be performed in parallel (e.g., matrix operations associated with neural networks). For instance, the neural engine may perform computer vision tasks such as object recognition. In some cases, the neural engine can be implemented based on various ML libraries such as PyTorch, which interfaces with the compute unified device architecture (CUDA) to parallelize operations.

In some aspects, the generative machine learning model 1208 may be a small generative model that has fewer parameters, fewer layers, fewer neurons, or a simpler architecture compared to larger models. A small generative model may not capture the full complexity of the underlying data distribution as effectively as larger models but can still be useful in scenarios where computational resources are limited or where a simpler model is sufficient for the task. Small generative models can also be easier to train and interpret, making them suitable for certain applications. For example, ChatGPT-3.5 has 175 billion parameters that results in a size of 1.4 Terabytes (TB) for a model implemented with double-precision floating point numbers. A smaller model may have a simpler architecture, use fewer parameters (e.g., 10 million), and use less precise numbers (e.g., single-precision floating point numbers) resulting in a size of 38 Megabytes (MB).

In addition, small models benefit from increased training based on local execution and data specific to a local device and a user of that local device. An additional benefit to small models is increased privacy because the information is not transmitted over the network and only relies on information requested by the user or usage at the local device.

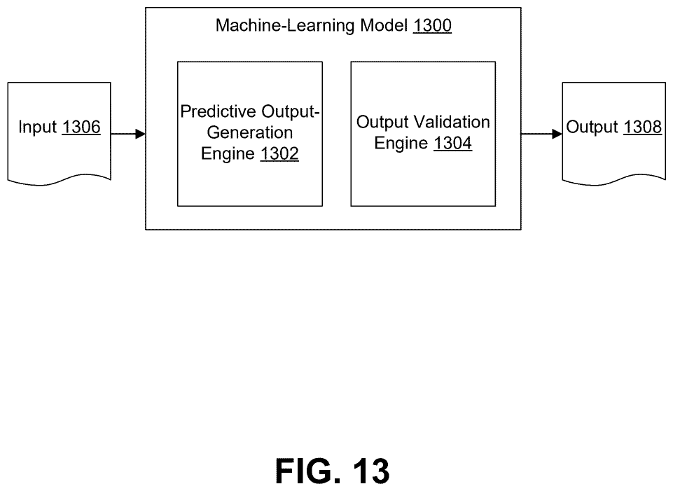

FIG. 13 includes an example machine-learning model 1300 that may be used in various aspects of the present disclosure. For example, machine-learning model 1300 may be implemented in a cloud, such as cloud 730, cloud 732, or cloud 734 of FIG. 7.

Machine-learning model 1300 is an example of a generative response engine. Generative response engines are commonly referred to as Generative AI. Generative response engines can receive an input prompt (e.g., input 1306) and generate content (e.g., output 1308) based on the prompt. Generative Pre-trained Transformers (GPTs), diffusion models, and diffusion-transformer models are some non-limiting examples of generative response engines.

Machine-learning model 1300 includes a predictive output-generation engine 1302 and Output validation engine 1304. Predictive output-generation engine 1302 may analyze input 1306 and identify relevant patterns and associations based on data on which predictive output-generation engine 1302 was trained. Further, predictive output-generation engine 1302 may predict a sequence of words that are the most likely continuation of input 1306. By iteratively predicting next words, predictive output-generation engine 1302 may aim to provide a coherent and contextually relevant answer to input 1306. Predictive output-generation engine 1302 may generate responses by sampling from the probability distribution of possible words and sequences, guided by the patterns observed during the training of predictive output-generation engine 1302. In some aspects, predictive output-generation engine 1302 may generate multiple possible responses before outputting a final one. The multiple responses may be variations that predictive output-generation engine 1302 considers potentially relevant and coherent. Output validation engine 1304 may evaluate the multiple generated responses based on certain criteria. These criteria can include relevance to the prompt, coherence, fluency, and sometimes adherence to specific guidelines or rules, depending on the application. Based on this evaluation, output validation engine 1304 may select a most appropriate response. This selection is typically the one that scores highest on the set criteria, balancing factors like relevance, informativeness, and coherence.

Input 1306 and/or output 1308 may be, or may include, text, image data, video data, numerical data, etc. For example, machine-learning model 1300 may perform tasks such as, text summarization, text translation, text generation, responding to queries, image description, video description, image generation (e.g., based on text and/or image data), video generation (e.g., based on text and/or image data), image rendering (e.g., based on a 3D model and/or image data), object detection (e.g., based on image data and/or video data) etc. As such, machine-learning model 1300 may be referred to as a large language model (LLM), a vision-language model (VLM), a multilingual language model (MLLM) a large vision model (LVM), etc.

FIG. 14 illustrates an example computing-device architecture 1400 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1400 may include, implement, or be included in any or all of device 402, WAP 412, WAP 422, device(s) 430, and/or repeater 440, all of FIG. 4, device 702, WAP 722, cloud 730, cloud 732, and/or cloud 734 all of FIG. 7, and/or other devices, modules, or systems described herein. Additionally or alternatively, computing-device architecture 1400 may be configured to perform process 800, process 900, process 1000, and/or other process described herein.

The components of computing-device architecture 1400 are shown in electrical communication with each other using connection 1412, such as a bus. The example computing-device architecture 1400 includes a processing unit (CPU or processor) 1402 and computing device connection 1412 that couples various computing device components including computing device memory 1410, such as read only memory (ROM) 1408 and random-access memory (RAM) 1406, to processor 1402.

Computing-device architecture 1400 can include a cache of high-speed memory connected directly with, in close proximity to, or integrated as part of processor 1402. Computing-device architecture 1400 can copy data from memory 1410 and/or the storage device 1414 to cache 1404 for quick access by processor 1402. In this way, the cache can provide a performance boost that avoids processor 1402 delays while waiting for data. These and other modules can control or be configured to control processor 1402 to perform various actions. Other computing device memory 1410 may be available for use as well. Memory 1410 can include multiple different types of memory with different performance characteristics. Processor 1402 can include any general-purpose processor and a hardware or software service, such as service 1 1416, service 2 1418, and service 3 1420 stored in storage device 1414, configured to control processor 1402 as well as a special-purpose processor where software instructions are incorporated into the processor design. Processor 1402 may be a self-contained system, containing multiple cores or processors, a bus, memory controller, cache, etc. A multi-core processor may be symmetric or asymmetric.

To enable user interaction with the computing-device architecture 1400, input device 1422 can represent any number of input mechanisms, such as a microphone for speech, a touch-sensitive screen for gesture or graphical input, keyboard, mouse, motion input, speech and so forth. Output device 1424 can also be one or more of a number of output mechanisms known to those of skill in the art, such as a display, projector, television, speaker device, etc. In some instances, multimodal computing devices can enable a user to provide multiple types of input to communicate with computing-device architecture 1400. Communication interface 1426 can generally govern and manage the user input and computing device output. There is no restriction on operating on any particular hardware arrangement and therefore the basic features here may easily be substituted for improved hardware or firmware arrangements as they are developed.

Storage device 1414 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 1406, read only memory (ROM) 1408, and hybrids thereof. Storage device 1414 can include services 1416, 1418, and 1420 for controlling processor 1402. Other hardware or software modules are contemplated. Storage device 1414 can be connected to the computing device connection 1412. In one aspect, a hardware module that performs a particular function can include the software component stored in a computer-readable medium in connection with the necessary hardware components, such as processor 1402, connection 1412, output device 1424, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for wireless networking, the apparatus comprising: at least one memory; and at least one processor coupled to the at least one memory and configured to: obtain a plurality of network identifiers of a corresponding plurality of wireless networks; generate a list of the plurality of network identifiers; determine related network identifiers from among the plurality of network identifiers; associate the related network identifiers in an enriched list of the plurality of network identifiers; determine a suspicious network from among the plurality of wireless networks; indicate a suspicious network identifier of the suspicious network in the enriched list; and display the enriched list.

Aspect 2. The apparatus of aspect 1, wherein the suspicious network is determined based on a message received from a device, and wherein the message is received over a network that is different from the plurality of wireless networks.

Aspect 3. The apparatus of any one of aspects 1 or 2, wherein, to determine the suspicious network, the at least one processor is configured to at least one of: identify the suspicious network identifier based on text-based rules; identify the suspicious network identifier by performing a search for the suspicious network identifier; or process the related network identifiers using a machine-learning model trained to identify the suspicious network identifier.

Aspect 4. The apparatus of any one of aspects 1 to 3, wherein the at least one processor is configured to: detect an indication of a trustworthy network in an image of an environment of the apparatus; and indicate a network identifier of the trustworthy network in the enriched list.

Aspect 5. The apparatus of any one of aspects 1 to 4, wherein the at least one processor is configured to: obtain a user input indicative of a network identifier of the plurality of network identifiers; connect the apparatus to a wireless network of the plurality of wireless networks that corresponds to the network identifier; test a security of the wireless network; and in response to a failed security test, disconnect from the wireless network and broadcasting a message indicating the failed security test of the wireless network.

Aspect 6. The apparatus of aspect 5, wherein, to test the security of the wireless network, the at least one processor is configured to at least one of: connect to a remote computing device via the wireless network; and receive data from the remote computing device; or perform a search based on the network identifier of the wireless network.

Aspect 7. The apparatus of any one of aspects 5 or 6, wherein, to broadcast the message, the at least one processor is configured to: connect to an additional wireless network of the plurality of wireless networks; and cause at least one transmitter to transmit the message to a networking device of the additional wireless network.

Aspect 8. An apparatus for processing data, the apparatus comprising: at least one memory; and at least one processor coupled to the at least one memory and configured to: obtain data at an extended reality (XR) device, wherein the data is based on at least one of image data captured by the XR device or audio data recorded by the XR device; capture an image of an environment associated with the data; classify the environment based on the image; determine a confidentiality level associated with the data based on the environment; determine a security protocol based on the confidentiality level; and cause at least one transmitter to transmit, based on the security protocol, the data to a remote computing device for processing.

Aspect 9. The apparatus of aspect 8, wherein the confidentiality level is determined based on at least one of: a location associated with the data; a time associated with the data; a calendar of a user of the XR device; an environment associated with the data; or content of the data.

Aspect 10. The apparatus of any one of aspects 8 or 9, wherein the at least one processor is configured to: capture an image of a representation of the data; and classify the data based on the image; wherein the confidentiality level is determined further based on the classification of the data.

Aspect 11. The apparatus of aspect 10, wherein, to classify the data based on the image, the at least one processor is configured to: detect a security indicator comprising at least one of keywords, a watermark, a quick response (QR) code, or a company confidential information (CCI) label in the image; and classify the data based on the security indicator.

Aspect 12. The apparatus of any one of aspects 8 to 11, wherein the at least one processor is configured to: store the confidentiality level; and apply the confidentiality level to other data, wherein the confidentiality level is applied to the other data based on the other data being obtained at least one of: at a related location; at a related time; or in association with a related calendar event.

Aspect 13. The apparatus of any one of aspects 8 to 12, wherein, to cause at least one transmitter to transmit, based on the security protocol, the data to the remote computing device for processing, the at least one processor is configured to determine to transmit the data to a remote computing device from among two or more remote computing devices based on the security protocol.

Aspect 14. The apparatus of any one of aspects 8 to 13, wherein, to cause at least one transmitter to transmit, based on the security protocol, the data to the remote computing device for processing, the at least one processor is configured to at least one of: determine an encryption protocol from among two or more encryption protocols based on the security protocol; and encrypt the data according to the encryption protocol prior to transmitting the data; determine a secure communication protocol from among two or more communication protocols based on the security protocol; and cause at least one transmitter to transmit the data to the remote computing device according to the secure communication protocol; or cause at least one transmitter to transmit the data with an instruction regarding how the data is to be processed, wherein the instruction is based on the security protocol.

Aspect 15. A method for wireless networking, the method comprising: obtaining a plurality of network identifiers of a corresponding plurality of wireless networks; generating a list of the plurality of network identifiers; determining related network identifiers from among the plurality of network identifiers; associating the related network identifiers in an enriched list of the plurality of network identifiers; determining a suspicious network from among the plurality of wireless networks; indicating a suspicious network identifier of the suspicious network in the enriched list; and displaying the enriched list.

Aspect 16. The method of aspect 15, wherein the suspicious network is determined based on a message received from a device, and wherein the message is received over a network that is different from the plurality of wireless networks.

Aspect 17. The method of any one of aspects 15 or 16, wherein determining the suspicious network comprises at least one of: identifying the suspicious network identifier based on text-based rules; identifying the suspicious network identifier by performing a search for the suspicious network identifier; or processing the related network identifiers using a machine-learning model trained to identify the suspicious network identifier.

Aspect 18. The method of any one of aspects 15 to 17, further comprising: detecting an indication of a trustworthy network in an image of an environment; and indicating a network identifier of the trustworthy network in the enriched list.

Aspect 19. The method of any one of aspects 15 to 18, further comprising: obtaining a user input indicative of a network identifier of the plurality of network identifiers; connecting to a wireless network of the plurality of wireless networks that corresponds to the network identifier; testing a security of the wireless network; and in response to a failed security test, disconnecting from the wireless network and broadcasting a message indicating the failed security test of the wireless network.

Aspect 20. The method of aspect 19, wherein testing the security of the wireless network comprises at least one of: connecting to a remote computing device via the wireless network; and receiving data from the remote computing device; or performing a search based on the network identifier of the wireless network.

Aspect 21. A method for computer networking, the method comprising: obtaining a plurality of network identifiers of a corresponding plurality of computer networks; generating a list of the plurality of network identifiers; enriching the list to generate an enriched list; and displaying the enriched list to a user of a device.

Aspect 22. The method of aspect 21, further comprising: determining a suspicious network from among the plurality of computer networks; and indicating a suspicious network identifier of the suspicious network in the enriched list.

Aspect 23. The method of aspect 22, wherein the suspicious network is determined based on a message received from another device.

Aspect 24. The method of aspect 23, wherein the message is received over a network that is different from the plurality of computer networks.

Aspect 25. The method of any one of aspects 21 to 24, wherein enriching the list comprises: determining related network identifiers from among the plurality of network identifiers; and grouping the related network identifiers together in the enriched list.

Aspect 26. The method of aspect 25, wherein the related network identifiers are related based on a similarity between the related network identifiers.

Aspect 27. The method of any one of aspects 25 or 26, wherein determining the related network identifiers comprises processing the list using a machine-learning model trained to group similar items of text.

Aspect 28. The method of any one of aspects 25 to 27, further comprising: determining a suspicious network identifier from among a group of related network identifiers; and indicating the suspicious network identifier in the enriched list.

Aspect 29. The method of aspect 28, wherein determine the suspicious network identifier comprises identifying the suspicious network identifier based on text-based rules.

Aspect 30. The method of any one of aspects 28 or 29, wherein determine the suspicious network identifier comprises processing the related network identifiers using a machine-learning model trained to identify suspicious network identifiers.

Aspect 31. The method of aspect 21, wherein enriching the list comprises: detecting an indication of a trustworthy network in an image of an environment of the device; and indicating a network identifier of the trustworthy network in the enriched list.

Aspect 32. The method of any one of aspects 21 to 31, wherein: the plurality of computer networks comprise Institute of Electrical and Electronics Engineers (IEEE) 802.11 (WiFi) networks; and the plurality of network identifiers comprise service set identifiers (SSIDs).

Aspect 33. The method of any one of aspects 21 to 32, wherein the device comprises an extended reality (XR) device.

Aspect 34. The method of any one of aspects 21 to 33, further comprising: obtaining a user input indicative of a network identifier of the plurality of network identifiers; and connecting the device to a computer network of the plurality of computer networks that corresponds to the network identifier.

Aspect 35. The method of aspect 34, further comprising: testing a security of the computer network; and in response to a failed security test, disconnecting from the computer network and broadcasting a message indicating the failed security test of the computer network.

Aspect 36. The method of aspect 35, wherein testing the security of the computer network comprises: connecting to a remote computing device via the computer network; and receiving data from the remote computing device.

Aspect 37. The method of any one of aspects 35 or 36, wherein testing the security of the computer network comprises performing a search based on the network identifier of the computer network.

Aspect 38. The method of any one of aspects 35 to 37, broadcasting the message comprises broadcasting the message using at least one of: a Bluetooth™ protocol; an ultra-wideband (UWB) protocol; or a millimeter wave (mmWave) protocol.

Aspect 39. The method of any one of aspects 35 to 38, broadcasting the message comprises: connecting to an additional computer network of the plurality of computer networks; and transmitting the message to a networking device of the additional computer network.

Aspect 40. The method of aspect 39, wherein the networking device of the additional computer network is configured to at least one of report or rebroadcast an indication of the failed security test of the computer network.

Aspect 41. The method of any one of aspects 34 to 40, further comprising: receiving a message indicating that the computer network is suspicious; and disconnecting from the computer network.

Aspect 42. The method of aspect 41, wherein the message is received according to at least one of: a Bluetooth™ protocol; an ultra-wideband (UWB) protocol; or a millimeter wave (mmWave) protocol.

Aspect 43. A method for processing data, the method comprising: obtaining data at a device; determining a confidentiality level associated with the data; determining a security protocol based on the confidentiality level; and transmitting, based on the security protocol, the data to a remote computing device for processing.

Aspect 44. The method of aspect 43, wherein: the device comprises an extended reality (XR) device; and the data is based on at least one of an image captured by the XR device or audio recorded by the XR device.

Aspect 45. The method of any one of aspects 43 or 44, wherein the confidentiality level is determined based on at least one of: a location associated with the data; a time associated with the data; a calendar of a user of the device; an environment associated with the data; or content of the data.

Aspect 46. The method of any one of aspects 43 to 45, further comprising: capturing an image of an environment associated with the data; and classifying the environment based on the image; wherein the confidentiality level is determined further based on the environment.

Aspect 47. The method of aspect 46, wherein classifying the environment comprises processing the image using a machine-learning model trained to classify environments.

Aspect 48. The method of any one of aspects 43 to 47, further comprising: capturing an image of a representation of the data; and classifying the data based on the image; wherein the confidentiality level is determined further based on the classification of the data.

Aspect 49. The method of aspect 48, wherein classifying the data based on the image comprises: detecting a security indicator comprising at least one of keywords, a watermark, a quick response (QR) code, or a company confidential information (CCI) label in the image; and classifying the data based on the security indicator.

Aspect 50. The method of any one of aspects 43 to 49, further comprising: storing the confidentiality level; and applying the confidentiality level to other data.

Aspect 51. The method of aspect 50, wherein the confidentiality level is applied to the other data based on the other data being obtained at least one of: at a related location; at a related time; or in association with a related calendar event.

Aspect 52. The method of any one of aspects 43 to 51, wherein transmitting, based on the security protocol, the data to a remote computing device for processing comprises determining to transmit the data to the remote computing device from among two or more remote computing devices based on the security protocol.

Aspect 53. The method of aspect 52, wherein: the remote computing device comprises a private computing device; and at least one other computing device of the two or more remote computing devices comprises a public computing device.

Aspect 54. The method of any one of aspects 43 to 53, wherein transmitting, based on the security protocol, the data to a remote computing device for processing comprises encrypting the data prior to transmitting the data based on the security protocol.

Aspect 55. The method of any one of aspects 43 to 54, wherein transmitting, based on the security protocol, the data to a remote computing device for processing comprises: determining an encryption protocol from among two or more encryption protocols based on the security protocol; and encrypting the data according to the encryption protocol prior to transmitting the data.

Aspect 56. The method of any one of aspects 43 to 55, wherein transmitting, based on the security protocol, the data to a remote computing device for processing comprises determining a secure communication protocol from among two or more communication protocols based on the security protocol.

Aspect 57. The method of any one of aspects 43 to 56, wherein transmitting, based on the security protocol, the data to a remote computing device for processing comprises transmitting the data with an instruction regarding how the data is to be processed, wherein the instruction is based on the security protocol.

Aspect 58. The method of any one of aspects 43 to 57, wherein the remote computing device is configured to at least one of: store the data; or process to generate output data.

Aspect 59. The method of aspect 58, wherein processing the data comprises at least one of: summarizing the data, the method further comprising providing a summary of the data to the device; translating the data, the method further comprising providing a translation of the data to the device; identifying an object in the data, the method further comprising providing an indication of the object to the device; or generating new data based on the data.

Aspect 60. A non-transitory computer-readable storage medium having stored thereon instructions that, when executed by at least one processor, cause the at least one processor to perform operations according to any of aspects 15 to 59.

Aspect 61. An apparatus, the apparatus comprising one or more means for perform operations according to any of aspects 15 to 59.

Aspect 62. An apparatus is provided that includes at least one memory and at least one processor (e.g., configured in circuitry) coupled to the at least one memory. The at least one processor configured to perform operations according to any of 15 to 59.

What is claimed is:

1. An apparatus for wireless networking, the apparatus comprising:
at least one memory; and
at least one processor coupled to the at least one memory and configured to:
obtain a plurality of network identifiers of a corresponding plurality of wireless networks;
generate a list of the plurality of network identifiers;
determine related network identifiers from among the plurality of network identifiers;
associate the related network identifiers in an enriched list of the plurality of network identifiers;
determine a suspicious network from among the plurality of wireless networks;
indicate a suspicious network identifier of the suspicious network in the enriched list; and
display the enriched list.

2. The apparatus of claim 1, wherein the suspicious network is determined based on a message received from a device, and wherein the message is received over a network that is different from the plurality of wireless networks.

3. The apparatus of claim 1, wherein, to determine the suspicious network, the at least one processor is configured to at least one of:
identify the suspicious network identifier based on text-based rules;
identify the suspicious network identifier by performing a search for the suspicious network identifier; or
process the related network identifiers using a machine-learning model trained to identify the suspicious network identifier.

4. The apparatus of claim 1, wherein the at least one processor is configured to:
detect an indication of a trustworthy network in an image of an environment of the apparatus; and
indicate a network identifier of the trustworthy network in the enriched list.

5. The apparatus of claim 1, wherein the at least one processor is configured to:
obtain a user input indicative of a network identifier of the plurality of network identifiers;
connect the apparatus to a wireless network of the plurality of wireless networks that corresponds to the network identifier;
test a security of the wireless network; and
in response to a failed security test, disconnect from the wireless network and broadcasting a message indicating the failed security test of the wireless network.

6. The apparatus of claim 5, wherein, to test the security of the wireless network, the at least one processor is configured to at least one of:
connect to a remote computing device via the wireless network; and
receive data from the remote computing device; or
perform a search based on the network identifier of the wireless network.

7. The apparatus of claim 5, wherein, to broadcast the message, the at least one processor is configured to:
connect to an additional wireless network of the plurality of wireless networks; and
cause at least one transmitter to transmit the message to a networking device of the additional wireless network.

8. An apparatus for processing data, the apparatus comprising:
at least one memory; and
at least one processor coupled to the at least one memory and configured to:
obtain data at an extended reality (XR) device, wherein the data is based on at least one of image data captured by the XR device or audio data recorded by the XR device;
capture an image of an environment associated with the data;
classify the environment based on the image;
determine a confidentiality level associated with the data based on the environment;
determine a security protocol based on the confidentiality level; and
cause at least one transmitter to transmit, based on the security protocol, the data to a remote computing device for processing.

9. The apparatus of claim 8, wherein the confidentiality level is determined based on at least one of:
a location associated with the data;
a time associated with the data;
a calendar of a user of the XR device;
an environment associated with the data; or
content of the data.

10. The apparatus of claim 8, wherein the at least one processor is configured to:
capture an image of a representation of the data; and
classify the data based on the image;
wherein the confidentiality level is determined further based on the classification of the data.

11. The apparatus of claim 10, wherein, to classify the data based on the image, the at least one processor is configured to:
detect a security indicator comprising at least one of keywords, a watermark, a quick response (QR) code, or a company confidential information (CCI) label in the image; and
classify the data based on the security indicator.

12. The apparatus of claim 8, wherein the at least one processor is configured to:
store the confidentiality level; and
apply the confidentiality level to other data, wherein the confidentiality level is applied to the other data based on the other data being obtained at least one of: at a related location; at a related time; or in association with a related calendar event.

13. The apparatus of claim 8, wherein, to cause at least one transmitter to transmit, based on the security protocol, the data to the remote computing device for processing, the at least one processor is configured to determine to transmit the data to a remote computing device from among two or more remote computing devices based on the security protocol.

14. The apparatus of claim 8, wherein, to cause at least one transmitter to transmit, based on the security protocol, the data to the remote computing device for processing, the at least one processor is configured to at least one of:
determine an encryption protocol from among two or more encryption protocols based on the security protocol;
encrypt the data according to the encryption protocol prior to transmitting the data;
determine a secure communication protocol from among two or more communication protocols based on the security protocol; and
cause at least one transmitter to transmit the data to the remote computing device according to the secure communication protocol; or
cause at least one transmitter to transmit the data with an instruction regarding how the data is to be processed, wherein the instruction is based on the security protocol.

15. A method for wireless networking, the method comprising:
obtaining a plurality of network identifiers of a corresponding plurality of wireless networks;
generating a list of the plurality of network identifiers;
determining related network identifiers from among the plurality of network identifiers;
associating the related network identifiers in an enriched list of the plurality of network identifiers;
determining a suspicious network from among the plurality of wireless networks;
indicating a suspicious network identifier of the suspicious network in the enriched list; and
displaying the enriched list.

16. The method of claim 15, wherein the suspicious network is determined based on a message received from a device, and wherein the message is received over a network that is different from the plurality of wireless networks.

17. The method of claim 15, wherein determining the suspicious network comprises at least one of:
identifying the suspicious network identifier based on text-based rules;
identifying the suspicious network identifier by performing a search for the suspicious network identifier; or
processing the related network identifiers using a machine-learning model trained to identify the suspicious network identifier.

18. The method of claim 15, further comprising:
detecting an indication of a trustworthy network in an image of an environment; and
indicating a network identifier of the trustworthy network in the enriched list.

19. The method of claim 15, further comprising:
obtaining a user input indicative of a network identifier of the plurality of network identifiers;
connecting to a wireless network of the plurality of wireless networks that corresponds to the network identifier;
testing a security of the wireless network; and
in response to a failed security test, disconnecting from the wireless network and broadcasting a message indicating the failed security test of the wireless network.

20. The method of claim 19, wherein testing the security of the wireless network comprises at least one of:
connecting to a remote computing device via the wireless network; and
receiving data from the remote computing device; or
performing a search based on the network identifier of the wireless network.
